(19) United States
(12) Patent Application Publication
(10) Pub. No.: US 2013/0157667 A1
(43) Pub. Date: Jun. 20, 2013

(54) TRANSMISSION DEVICE, RECEPTION DEVICE, RELAY DEVICE, COMMUNICATION SYSTEM, TRANSMISSION METHOD, RECEPTION METHOD, RELAY METHOD, COMMUNICATION METHOD, COMPUTER PROGRAM, AND SEMICONDUCTOR CHIP

(71) Applicant: Sharp Kabushiki Kaisha, Osaka (JP)

(72) Inventors: Osamu NAKAMURA, Osaka-shi (JP); Hiroki TAKAHASHI, Osaka-shi (JP); Jungo GOTO, Osaka-shi (JP); Kazunari YOKOMAKURA, Osaka-shi (JP); Yasuhiro HAMAGUCHI, Osaka-shi (JP)

(73) Assignee: SHARP KABUSHIKI KAISHA, Osaka (JP)

(21) Appl. No.: 13/773,034

(22) Filed: Feb. 21, 2013

Related U.S. Application Data
(63) Continuation-in-part of application No. PCT/JP2011/068561, filed on Aug. 16, 2011.

(30) Foreign Application Priority Data
Aug. 27, 2010 (JP) 2010-191569

(51) Int. Cl. H04W 8/08

(52) U.S. Cl. 455/440; 455/454

(57) ABSTRACT

[Object] To estimate a channel with high accuracy by a receiver without an increase in scale or an increase in power consumption of a device because of use of complicated calculation, even when a transmission device or a relay device uses different frequencies.

[Solution] A mapping unit that provides a frequency allocation that is different for each of transmit antennas; and a reference signal generator that determines a reference signal sequence for each of the transmit antennas so that the same sequence is transmitted from the transmit antennas with each frequency after the mapping by the mapping unit, are included.

### TECHNICAL FIELD

The present invention relates to a transmission device, a reception device, a relay device, a communication system, a transmission method, a reception method, a relay method, a communication method, a computer program, and a semiconductor chip.

### BACKGROUND ART

Radio communication, in particular, the LTE (long term evolution) system, which is the 3.9-generation mobile phone radio communication system, employs OFDM (orthogonal frequency division multiplexing) as a transmission scheme in downlink (communication from a base station to a terminal). This is because OFDM has high tolerance to frequency selective fading, high compatibility with MIMO (multiple input multiple output) transmission, and flexibility for frequency-domain scheduling. In contrast, in uplink (communication from the terminal to the base station) of the LTE, it is important to reduce the cost and power consumption of the terminal. However, the OFDM has a high PAPR (peak to average power ratio), and hence a power amplifier with a wide linear domain and a large power consumption is required. Thus, the OFDM is not suitable for the uplink transmission. Owing to this, SC-FDMA (single carrier frequency division multiple access, occasionally called DFT-S-OFDM) with a low PAPR is employed.

In the radio communication, a transmitter (for example, a transmission portion of the terminal) transmits data as a transmission signal, the amplitude and phase of this transmission signal are changed by fading in a channel, and then the transmission signal reaches a receiver (for example, a reception portion of the base station). Hence, the receiver has to estimate a variation in the channel and provide compensation for the fading. The estimation for the channel uses a method, in which the transmitter transmits a signal which is known by the transmitter and receiver (called reference signal, pilot signal, or preamble signal), the receiver estimates the channel based on the received reference signal, and a data signal is demodulated by using the obtained channel estimation value.

In particular, in the uplink of the LTE, a demodulation reference signal is called a DMRS (demodulation reference signal).

Otherwise, a sounding reference signal SRS is used to estimate channel quality between a transmit antenna of the terminal and a receive antenna of the base station, in not only a band in which a data signal is transmitted but also the entire system band.

Meanwhile, for a sequence of the DMRS may use a Zadoff-Chu sequence (abbreviated as ZC sequence) that has good auto-correlation characteristics and good cross-correlation characteristics and is one of low PAPR sequences (this may be applied to a SRS sequence). The ZC sequence is generated by an allocation frequency bandwidth M^{RS}_{sc} to which the DMRS is allocated, and a ZC sequence index q that is determined by notification information from the base station.

In the LTE, a frequency allocation is provided with the minimum unit of a resource block RB that is formed of 12 resource elements (occasionally called subcarriers, frequency points, or orthogonal frequencies). If the number of RBs to be used in the LTE is three or larger, a sequence r(n) of the DMRS with the length M^{RS}_{sc} is represented by the following expression.

[Math. 1]

r(n)=x_{q}(n mod N_{ZC}^{RS}), 0≦n≦M_{sc}^{RS}−1 Expression (1)

Here, N^{RS}_{ZC} is a maximum prime number that does not exceed M^{RS}_{sc} and mod is a function for obtaining a remainder of division.

The above-described r(n) is obtained by copying the former half of a ZC sequence x_{q} (a portion corresponding to the size of M^{RS}_{sc}-N^{RS}_{ZC}) and adding the former half to the latter half, to cause the ZC sequence x_{q} with the prime number length to match the frequency bandwidth of the DMRS (the number of subcarriers that is an integral multiple of 12). Hence, the above-described r(n) is a value obtained by cyclically extending the ZC sequence x_{q} with the prime number length.

Meanwhile, the ZC sequence x_{q}(m) with the ZC sequence index being q is represented by the following expression.

$$\begin{matrix}[ Math . 2 ] & \\ {x}_{q} ( m ) = exp ( - j \frac{π qm ( m + 1 )}{{N}_{ZC}^{RS}} ) , \\ 0 \leq m \leq {N}_{ZC}^{RS} - 1 & Expression ( 2 )\end{matrix}$$

Also, if the number of RBs to be used is one or two, that is, if M^{RS}_{sc}=12, 24, r(n) is a sequence represented by Expression (3) as follows.

[Math. 3]

r(n)=exp(jφ(n)/4), 0≦n≦M_{sc}^{RS}−1 Expression (3)

Here, values of φ(n) are written in 5.5.1.2 of NPL 1. FIGS. 33 and 34 show part of the values. Numbers of 0, 1, . . . and 29 in the left column in each of FIGS. 33 and 34 indicate sequence numbers. FIG. 33 is a case when M^{RS}_{sc}=12. FIG. 34 is a case when M^{RS}_{sc}=24.

In general terms, the terminal transmits, as the DMRS, r^{(α)} (n), which is obtained by applying a linear phase offset represented by the following expression to the acquired sequence r(n).

[Math. 4]

r^{(α)}(n)=exp(jαn)r(n) Expression (4)

The value of α is a value obtained in accordance with a value which is notified from the base station. Since processing is the same as applying a cyclic shift to a time signal, this operation is called cyclic shift (occasionally called CS).

In the uplink of the LTE, transmission of data simultaneously from a plurality of transmit antennas of a single terminal is not specified. However, in uplink of LTE-A (long term evolution advanced, advanced LTE) for providing higher speed and wider band of the LTE, introduction of SU-MIMO (single user MIMO) in which data is simultaneously transmitted from a plurality of transmit antennas of a single terminal has been decided. In the SU-MIMO, the plurality of transmit antennas of the single terminal transmit independent data, and a base station separates and detects the data. The number of pieces of the simultaneously transmitted independent data is called the rank (occasionally called the number of streams or the number of layers).

Also, as described above, in the uplink of the LTE-A, transmission is performed with the same frequency by all transmit antennas of the single terminal. However, the transmit antennas respectively have different frequencies for providing good channel characteristics.

PTL 1 and PTL 2 each describe a method of transmitting data with frequency arrangements being different respectively for transmit antennas. Since the different frequency arrangements are allowed respectively for the transmit antennas, communication can be made by selecting a frequency with a high gain for each of the transmit antennas. Spatial multiplexing transmission with high reception quality can be performed.

Also, in the uplink of the LTE, MU-MIMO (multi-user MIMO) in which a plurality of terminals simultaneously make accesses to a single base station with use of the same frequency band has been introduced. In the LTE-A, it is studied that a plurality of terminals perform the above-described MU-MIMO with use of different frequency bands.

As described above, the SU-MIMO or MU-MIMO in which transmission is performed with different frequency allocations with use of a plurality of transmit antennas (with use of a plurality of transmit antennas of a single terminal, or with use of transmit antennas of a plurality of terminals each including one or a plurality of transmit antennas) is studied.

### CITATION LIST

### Patent Literature

PTL 1: Japanese Unexamined Patent Application Publication No. 2008-199598
PTL 2: Pamphlet of International Publication No. WO/2009/022709

### Non Patent Literature

NPL 1: 3GPP TS 36.211 V8.9.0

### SUMMARY OF INVENTION

### Technical Problem

To perform the above-described SU-MIMO or MU-MIMO, channels between a plurality of transmit antennas of a single transmitter (for example, a transmission portion of a terminal) or transmit antennas of a plurality of transmitters each including one or a plurality of transmit antennas (a plurality of transmit antennas in entirety), and one or a plurality of receive antennas of a single receiver (for example, a reception portion of a base station) have to be estimated. If the respective antennas use common subcarriers like the uplink SU-MIMO in the LTE-A and the uplink MU-MIMO in the LTE, the respective transmit antennas use a common sequence r(n) of a demodulation reference signal (DMRS). Hence, by applying different cyclic shifts respectively to the transmit antennas, the receiver can separate DMRSs of the respective transmit antennas.

However, if the DMRSs are generated when the antennas use uncommon subcarriers, the DMRSs transmitted from the respective transmit antennas with each frequency are different. Hence, the receiver cannot separate the received DMRSs for the respective transmit antennas by merely applying a linear phase offset in the frequency domain (that is, cyclic shift in the time domain). In this case, the channel of each transmit antenna can be estimated by using complicated calculation such as inverse matrix calculation. However, an increase in scale and an increase in power consumption of the device arise. Also, channel estimation accuracy may be markedly degraded depending on the degree of correlation between ZC sequences. This is also a problem in transmission of the above-described sounding reference signal SRS. This is also a problem even when a relay device is used.

An object of the present invention is to address the above-described problems.

### Solution to Problem

(1) The present invention is made to address the above-described problems, and a transmission device according to the present invention is one or a plurality of transmission devices each of which includes one or a plurality of transmit antennas, the transmission device including: a mapping unit that provides a frequency allocation that is different for each of the transmit antennas; and a reference signal generator that determines a reference signal sequence for each of the transmit antennas so that the same sequence is transmitted from the transmit antenna with each frequency after the mapping by the mapping unit.

(2) Also, a transmission device according to the present invention is the above-described transmission device, in which the reference signal generator includes a reference signal sequence generator that generates a single reference signal sequence, and a frequency domain cyclic shifter that applies a cyclic shift in the frequency domain to the reference signal sequence and hence generates the reference signal sequence for each of the transmit antennas.

(3) Also, a transmission device according to the present invention is the above-described transmission device, in which the reference signal generator includes a cyclic extender that cyclically extends an output of the frequency domain cyclic shifter so that the output matches a bandwidth of the frequency allocation.

(4) Also, a transmission device according to the present invention is the above-described transmission device, in which the reference signal sequence generator generates the reference signal sequence based on a frequency allocation to a path of an antenna with the widest frequency allocation among the transmit antennas by the mapping unit.

(5) Also, a transmission device according to the present invention is the above-described transmission device, in which the reference signal is a demodulation reference signal.

(6) Also, a transmission device according to the present invention is the above-described transmission device, in which the reference signal is a sounding reference signal.

(7) The present invention is made to address the above-described problems, and a reception device according to the present invention is a reception device including one or a plurality of receive antennas, the reception device including: a reference signal separator that separates a received reference signal from a data signal; a weight generator that generates a weight without inverse matrix calculation; and a MIMO separator that separates the received data signal by using the weight.

(8) The present invention is made to address the above-described problems, and a communication system according to the present invention is a communication system including one or a plurality of transmission devices each of which includes one or a plurality of transmit antennas, and a reception device which includes one or a plurality of receive antennas that receive a signal transmitted from the transmission device, in which the transmission device includes a mapping unit that provides a frequency allocation that is different for each of the transmit antennas, and a reference signal generator that determines a reference signal sequence for each of the transmit antennas so that the same sequence is transmitted from the transmit antenna with each frequency after the mapping by the mapping unit, and in which the reception device includes a reference signal separator that separates a received reference signal from a data signal, a weight generator that generates a weight without inverse matrix calculation, and a MIMO separator that separates the received data signal by using the weight.

(9) The present invention is made to address the above-described problems, and a transmission method according to the present invention includes: mapping a frequency allocation that is different for each of one or a plurality of transmit antennas, for a reference signal and a data signal; and after the mapping, transmitting the reference signal and the data signal from the transmit antenna with each frequency, and during the transmission of the reference signal and the data signal, transmitting a reference signal sequence that is the same sequence for each of the transmit antennas.

(10) The present invention is made to address the above-described problems, and a reception method according to the present invention includes: separating a received reference signal from a data signal; generating a weight without inverse matrix calculation; and separating the received data signal by using the weight.

(11) The present invention is made to address the above-described problems, and a communication method according to the present invention includes: mapping a frequency allocation that is different for each of one or a plurality of transmit antennas, for a reference signal and a data signal; after the mapping, transmitting the reference signal and the data signal from the transmit antenna with each frequency; separating the received reference signal from the data signal; generating a weight without inverse matrix calculation; and separating the received data signal by using the weight.

(12) The present invention is made to address the above-described problems, and a program according to the present invention realizes a function of the transmission device according to the above description (1).

(13) The present invention is made to address the above-described problems, and a semiconductor chip according to the present invention includes a semiconductor integrated circuit that realizes a function of the transmission device according to the above description (1).

(14) The present invention is made to address the above-described problems, and a relay device according to the present invention is a relay device that receives a signal transmitted from one or a plurality of transmission devices and relays the signal to a reception device, the relay device including: a mapping unit that provides a frequency allocation that is different from a frequency allocation of the transmission device; and a reference signal generator that determines a reference signal sequence so that the same sequence as a sequence from the transmission device is transmitted with each frequency after the mapping by the mapping unit.

(15) The present invention is made to address the above-described problems, and a relay method according to the present invention includes: receiving a signal transmitted from one or a plurality of transmission devices; mapping a frequency allocation that is different form a frequency allocation for the transmission device, for the received signal; and during the mapping, determining a reference signal sequence so that the same sequence as a sequence from the transmission device is transmitted with each frequency.

### Advantageous Effects of Invention

With the present invention, in the MIMO transmission or transmission through the relay device, even when the transmit antennas respectively use different frequencies, channels can be estimated with high accuracy by a reception side without an increase in scale or an increase in power consumption of the device because of the use of complicated calculation.

### BRIEF DESCRIPTION OF DRAWINGS

FIG. 1 is an illustration showing a brief overview of a radio communication system common to first to fifth embodiments of the present invention.

FIG. 2 is a brief block diagram showing a configuration of a terminal according to the first embodiment.

FIG. 3 is an illustration showing an example of a configuration of a transmission frame.

FIG. 4 is an illustration showing an example of a configuration of a DMRS generator.

FIG. 5 is an illustration schematically showing outputs of the DMRS generator.

FIG. 6 is an illustration schematically showing other some outputs of a mapping unit.

FIG. 7 is a brief block diagram showing a configuration of a base station according to the first embodiment.

FIG. 8 is an illustration showing a configuration of a MIMO separator.

FIG. 9 is an illustration explaining channel estimation by using an example of an output when the number of transmit antennas is two.

FIG. 10 is a brief block diagram showing a configuration of a terminal according to the second embodiment.

FIG. 11 is an illustration showing an example of a configuration of a DMRS generator.

FIG. 12 is an illustration schematically showing outputs of the DMRS generator.

FIG. 13 is an illustration schematically showing outputs of a mapping unit.

FIG. 14 is a brief block diagram showing a configuration of a terminal according to the third embodiment.

FIG. 15 is an illustration showing an example of a configuration of a DMRS generator.

FIG. 16 is an illustration schematically showing outputs of the DMRS generator.

FIG. 17 is an illustration schematically showing outputs of a mapping unit.

FIG. 18 is a brief block diagram showing a configuration of one of two terminals according to the fourth embodiment.

FIG. 19 is a brief block diagram showing a configuration of the other of the two terminals according to the fourth embodiment.

FIG. 20 is an illustration showing an example of a configuration of a DMRS generator.

FIG. 21 is a brief block diagram showing a configuration of one of two terminals according to the fifth embodiment.

FIG. 22 is a brief block diagram showing a configuration of the other of the two terminals according to the fifth embodiment.

FIG. 23 is a brief block diagram showing a configuration of an OFDM signal generator.

FIG. 24 is an illustration showing an example of a configuration of a SRS generator.

FIG. 25 is an illustration schematically explaining generation of a comb spectrum and its orthogonal relationship.

FIG. 26 is an illustration schematically showing outputs of a SRS multiplexer.

FIG. 27 is an illustration showing a brief overview of a radio communication system according to a sixth embodiment of the present invention.

FIG. 28 is a brief block diagram showing a configuration of a terminal according to the sixth embodiment.

FIG. 29 is a brief block diagram showing a configuration of a relay station according to the sixth embodiment.

FIG. 30 is an illustration showing an example of a configuration of a signal processor.

FIG. 31 is an illustration schematically showing frequency arrangements used by a terminal and a relay station for transmission to a base station.

FIG. 32 is a brief block diagram showing a configuration of a base station according to the sixth embodiment.

FIG. 33 is a table showing an example of factors of sequences of reference signals.

FIG. 34 is a table showing another example of factors of sequences of reference signals.

### DESCRIPTION OF EMBODIMENTS

In this description, a DMRS (demodulation reference signal) and a SRS (sounding reference signal) are known signals for both a transmitter and a receiver and are used for estimating a channel state. In W-CDMA (3rd generation mobile phone), the signals are called a pilot signal (pilot symbol). Hereinafter, embodiments are described based on that the transmission scheme is SC-FDMA. However, the present invention may be applied when the transmission scheme is OFDM. Also, in the embodiments, arrangement of the DMRS and the SRS in uplink is described. However, this arrangement may be applied to downlink.

Hereinafter, the embodiments of the present invention are described with reference to the drawings.

### First Embodiment

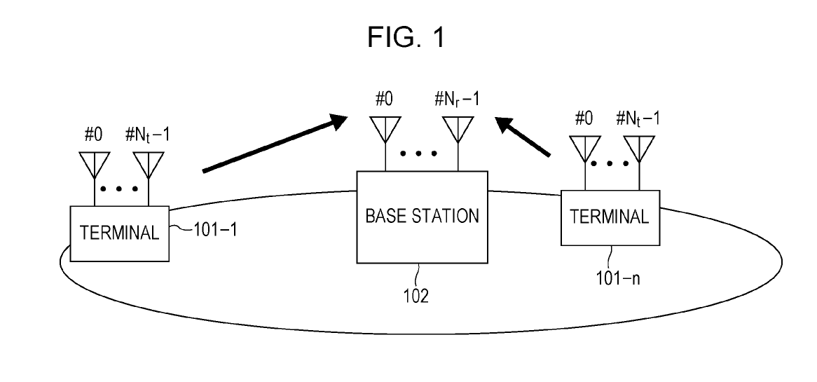

FIG. 1 is an illustration showing a brief overview of a radio communication system common to first to fifth embodiments of the present invention.

The radio communication system in FIG. 1 includes a plurality of terminals 101-1 . . . 101-n, and a single base station 102. FIG. 1 shows only the two terminals for easier viewing of the drawing. The terminals 101-1 to 101-n are collectively called terminal 101. Also, the terminal is occasionally called terminal device, mobile station, or transmission device. Similarly, the base station is occasionally called base station device or reception device.

The terminal 101 includes a plurality of (a number Nt of) transmit antennas #0 to #Nt−1. The base station 102 includes one or a plurality of (a number Nr of) receive antennas #0 to #Nr−1.

In FIG. 1, in uplink of SU-MIMO, the single terminal 101 uses the plurality of transmit antennas #0 to #Nt−1 and hence transmits a radio signal including a reference signal to the single base station 102 including the one or the plurality of receive antennas #0 to #Nr−1. Similarly in FIG. 1, in uplink of MU-MIMO, the plurality of terminals 101 including the one or the plurality of transmit antennas #0 to #Nt−1 use the respective transmit antennas and hence transmit radio signals including reference signals to the single base station 102 including the one or the plurality of receive antennas #0 to #Nr−1.

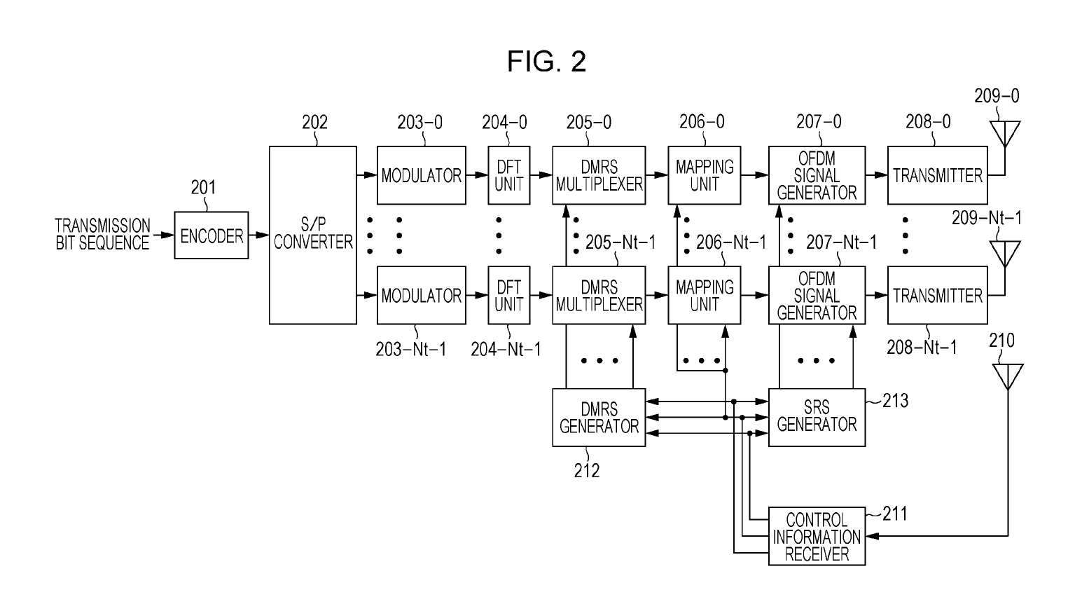

FIG. 2 is a brief block diagram showing a configuration of the terminal 101 according to the first embodiment.

The terminal 101 includes an encoder 201, a S/P converter 202, modulators 203-0 to 203-Nt−1, DFT units 204-0 to 204-Nt−1, DMRS multiplexers 205-0 to 205-Nt−1, mapping units 206-0 to 206-Nt−1, OFDM signal generators 207-0 to 207-Nt−1, transmitters 208-0 to 208-Nt−1, transmit antennas 209-0 to 209-Nt−1, a receive antenna 210, a control signal receiver 211, a DMRS generator 212, and a SRS generator 213.

Other known configuration included in the terminal 101 for the radio communication is omitted in FIG. 2 for easier understanding of the description. This is also applied to the other embodiments.

In the configuration of the terminal 101 in FIG. 2, it is assumed that the number of transmit antennas is Nt, and the number of simultaneous transmission streams (also called rank or layers) is also Nt.

The encoder 201 applies error correction encoding to a transmission bit sequence of data, such as audio data, character data, or image data. The output of the encoder 201 is input to the S/P (serial to parallel) converter 202. The S/P converter 202 performs serial-parallel conversion on the input sequence to correspond to the number Nt of simultaneous transmit antennas. The output of the S/P converter 202 is input to the modulators 203-0 to 203-Nt−1. Each modulator converts the input bit sequence into a modulation signal on a symbol basis of, for example, QPSK (quadrature phase shift keying, 4-phase phase modulation) or 16QAM (quadrature amplitude modulation, 16-value orthogonal amplitude modulation), and outputs the modulation signal. The DFT units 204-0 to 204-Nt−1 that perform NDFT-point discrete Fourier transform apply discrete Fourier transform (also called DFT) to the outputs of the modulators 203-0 to 203-Nt−1. Hence, a time domain signal is converted into a frequency domain signal.

The outputs of the DFT units 204-0 to 204-Nt−1 are input to the DMRS multiplexers 205-0 to 205-Nt−1.

The DMRS multiplexers 205-0 to 205-Nt−1 multiplex data signals output from the DFT units 204-0 to 204-Nt−1 on a demodulation reference signal DMRS input from the DMRS generator 212, and form transmission frames. The DMRS generator 212 is described later.

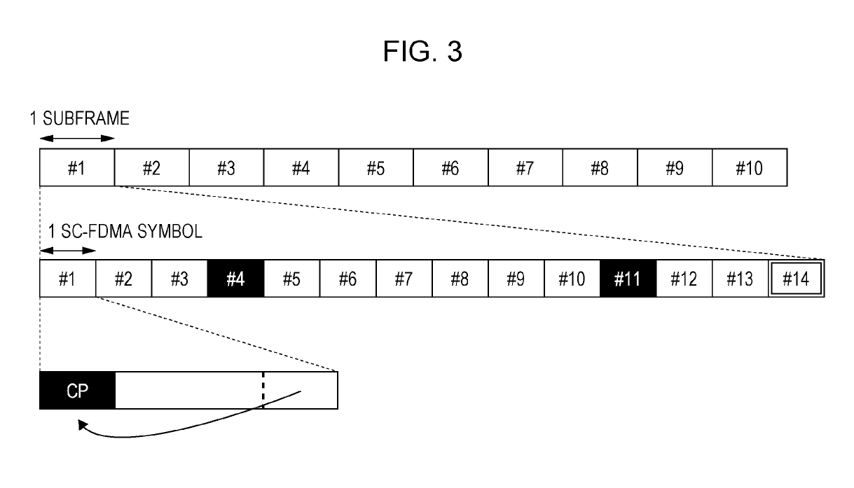

FIG. 3 shows an example of a transmission frame configuration.

A single frame shown in the upper row in FIG. 3 is formed of 10 subframes on the time axis. A single subframe shown in the middle row in FIG. 3 is formed of 14 symbols in total including 12 data SC-FDMA symbols and 2 DMRS symbols. Here, the DMRS symbol is inserted to a 4th symbol (#4) and an 11th symbol (#11) among the 14 symbols as shown in the middle row in FIG. 3. Also, regarding a 14th (#14) SC-FDMA symbol in each subframe, a data SC-FDMA symbol or a SRS (sounding reference signal) symbol may be transmitted. The symbol to be transmitted is notified by the base station 102 to the terminal 101.

The outputs of the DMRS multiplexers 205-0 to 205-Nt−1 are input to the mapping units 206-0 to 206-Nt−1.

The mapping units 206-0 to 206-Nt−1 perform mapping for each of the SC-FDMA symbols, based on allocation information input from the control information receiver 211, to correspond to a frequency point selected from NFFT points based on the allocation information. It is to be noted that NDFT is an integral multiple of the number of subcarriers forming the RB, and NDFT<NFFT is established.

Here, the control information receiver 211 is described. The control information receiver 211 receives control information from the base station 102 through the receive antenna 210.

To be more specific, the control information receiver 211 receives a signal transmitted from the base station 102 by the receive antenna 210, and performs down conversion from a carrier frequency to a baseband signal, A/D conversion, orthogonal frequency demodulation, and fast Fourier transform. After the fast Fourier transform, the control information receiver 211 performs extraction, demodulation, and decoding of a symbol sequence, extracts a signal having control information and a bit sequence of reception data, and inputs allocation information in the control information to the mapping units 206-0 to 206-Nt−1. Also, the control information receiver 211 extracts a sequence number q of a ZC sequence from the control information, and inputs the extracted value to the DMRS generator and the SRS generator. Also, the control information receiver 211 extracts allocation information and a cyclic shift α for DMRS, and inputs these pieces of information to the DMRS generator 212. Further, the control information receiver 211 extracts allocation information and a cyclic shift α for SRS, and inputs these pieces of information to the SRS generator 213.

The outputs of the mapping units 206-0 to 206-Nt−1 are input to the OFDM signal generators 207-0 to 207-Nt−1.

As shown in FIG. 3, when a transmission request of the sounding reference signal SRS is notified through the control information from the base station 102, the respective OFDM signal generators 207-0 to 207-Nt−1 multiplex the SRS input from the SRS generator 213 on the outputs of the mapping units 206-0 to 206-Nt−1. The SRS generator 213 receives information required for the generation of the SRS and allocation information from the control information receiver 211.

This multiplexing is performed by inserting the SRS to the 14th symbol #14 in the single subframe in FIG. 3 as described above. However, the insertion of the SRS is not limited to this method.

Then, the OFDM signal generators 207-0 to 207-Nt−1 apply the NFFT-point inverse fast Fourier transform (IFFT), to perform conversion on the input signals from the mapping units 206-0 to 206-Nt−1 (if the multiplexing of the SRS is performed, the multiplexed signals) from frequency domain signals to time domain signals.

Then, as shown in the lower row in FIG. 3, a CP (cyclic prefix) is inserted into each of the SC-FDMA symbols. The CP employs a copy of a portion for a certain time cut from the backend of the SC-FDMA symbol, and the copy is inserted to the frontend of the SC-FDMA symbol. The SC-FDMA symbols after CPs are inserted are input to the transmitters 208-0 to 208-Nt−1. The transmitters 208-0 to 208-Nt−1 perform D/A (digital-analog) conversion, analog filtering, upconversion to a carrier frequency, etc., on the input SC-FDMA symbols, and then transmits carrier signals from the transmit antennas 209-0 to 209-Nt−1.

Here, the DMRS generator 212 is described in detail.

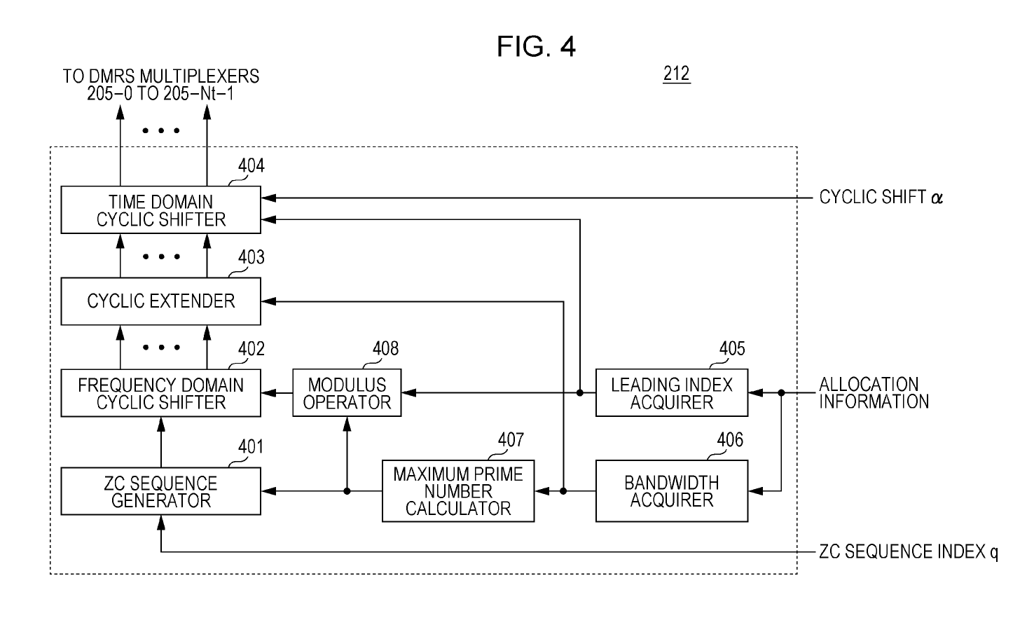

FIG. 4 shows an example of a configuration of the DMRS generator 212.

The DMRS generator 212 includes a ZC sequence generator 401, a frequency domain cyclic shifter 402, a cyclic extender 403, a time domain cyclic shifter 404, a bandwidth acquirer 406, a leading index acquirer 405, a maximum prime number calculator 407, and a modulus operator 408.

First, allocation information input from the control information receiver 211 (FIG. 2) is input to the bandwidth acquirer 406 and the leading index acquirer 405. The bandwidth acquirer 406 acquires an allocation bandwidth MRSsc of each transmit antenna from the input allocation information, and inputs the acquired value to the maximum prime number calculator 407 and the cyclic extender 403.

The maximum prime number calculator 407 calculates a maximum prime number NRSZC that does not exceed the MRSsc, from the input bandwidth MRSsc. For example, if MRSsc=36, the maximum prime number that does not exceed 36 is 31, and hence NRSZC=31. The calculation of a prime number may use an algorism such as “Sieve of Eratosthenes,” or since the upper limit of the MRSsc is limited, a table of prime numbers may be stored in a storage device (not shown), and a prime number may be derived from the table of prime numbers.

The output NRSZC of the maximum prime number calculator 407 is input to the ZC sequence generator 401 and the modulus operator 408. The ZC sequence generator 401 generates a ZC sequence xq(m) (0≦m≦NRSZC−1) with a length of the NRSZC by the input NRSZC, the ZC sequence index q input from the control information receiver 211 (FIG. 2), and Expression (2), and inputs the generated sequence to the frequency domain cyclic shifter 402.

Also, the leading index acquirer 405 acquires a frequency index kTOP,u at the leading end of frequency allocation for a u-th transmit antenna, from the allocation information input from the control information receiver 211 (FIG. 2), and inputs the acquired value to the modulus operator 408.

For example, in Table 1, the number of transmit antennas is 3, 36 subcarriers are allocated to 24th to 59th frequency points for a 0th transmit antenna, 36 subcarriers are allocated to 48th to 83rd frequency points for a 1st transmit antenna, and 36 subcarriers are allocated to 36th to 71st frequency points for a 2nd transmit antenna. In the case of allocation as shown in Table 1, kTOP,0=24, kTOP,1=48, and kTOP,2=36, which are frequency indices at the leading ends of the 0th to 2nd transmit antennas are extracted, and are input to the modulus operator 408 and the time domain cyclic shifter 404.

TABLE 1

| | Allocation |
|---|---|
| 0th transmit antenna | 24 to 59 |
| 1st transmit antenna | 48 to 83 |
| 2nd transmit antenna | 36 to 71 |

The modulus operator 408 calculates a cyclic shift amount Δᵤ of each transmit antenna by the following expression, based on the index k_{TOP,u} at the leading end of each transmit antenna input from the leading index acquirer 405 and N^{RS}_{ZC} input from the maximum prime number calculator 407.

[Math. 5]

Δᵤ=k_{TOP,u} mod N_{ZC}^{RS} Expression (5)

For example, if the frequency allocations for the respective antennas are as shown in Table 1, since N^{RS}_{ZC}=31, Δ₀=24, Δ₁=17, and Δ₂=5 are calculated based on Expression (5). The cyclic shift amount Δᵤ for each transmit antenna calculated by the modulus operator 408 is input to the frequency domain cyclic shifter 402.

In the above example, the cyclic shift amount Δᵤ is determined with reference to the frequency index. However, the cyclic shift amount Δᵤ may be any value as long as the correlation among the transmit antennas can be maintained. For example, even if the cyclic shift amount Δ₀ of the 0th transmit antenna is constantly 0, and Δ₁=24 and Δ₂=12 with reference to the 0th transmit antenna, the correlation among the transmit antennas is maintained, and the advantage of this embodiment can be attained.

The frequency domain cyclic shifter 402 calculates a sequence x_{q,u}(m) for each transmit antenna by using x_{q}(m) input from the ZC sequence generator 401 and Δᵤ input from the modulus operator 408, based on the following expression.

[Math. 6]

x_{q,u}(m)=x_{q}((m+Δᵤ)mod N_{AC}^{RS}), 0≦m≦N_{ZC}^{RS}−1 Expression (6)

That is, the frequency domain cyclic shifter 402 performs processing for applying a cyclic shift to a ZC sequence. The cyclic shift of the frequency domain cyclic shifter 402 is a cyclic shift in the frequency domain, and is different from a cyclic shift in the time domain.

The above matter is described again.

For example, in the case of the frequency allocations in Table 1, a sequence vector x_{q,u} for the u-th transmit antenna output from the frequency domain cyclic shifter 402 is represented by the following expression.

$$\begin{matrix} [ Math . 7 ] & \\ \{ \begin{matrix}{x}_{q , 0} = [ \begin{matrix}{x}_{q} ( 24 ) & {x}_{q} ( 25 ) & … & {x}_{q} ( 30 ) & {x}_{q} ( 0 ) & … & {x}_{q} ( 23 )\end{matrix} ] \\ {x}_{q , 1} = [ \begin{matrix}{x}_{q} ( 17 ) & {x}_{q} ( 18 ) & … & {x}_{q} ( 30 ) & {x}_{q} ( 0 ) & … & {x}_{q} ( 16 )\end{matrix} ] \\ {x}_{q , 2} = [ \begin{matrix}{x}_{q} ( 5 ) & {x}_{q} ( 6 ) & … & {x}_{q} ( 30 ) & {x}_{q} ( 0 ) & … & {x}_{q} ( 4 )\end{matrix} ]\end{matrix} & Expression ( 7 )\end{matrix}$$

The sizes of three vectors at the left sides of Expression (7) are each 1×N^{RS}_{ZC} (sequences of single-sequence N^{RS}_{ZC} arrays). The sequence x_{q,u}(m) for each transmit antenna calculated by the frequency domain cyclic shifter 402 is input to the cyclic extender 403. The cyclic extender 403 calculates rᵤ(n) by using the sequence x_{q,u}(m) with the length N^{RS}_{ZC} input from the frequency domain cyclic shifter 402, the bandwidth M^{RS}_{sc} input from the bandwidth acquirer 406, and the following expression.

[Math. 8]

rᵤ(n)=x_{q,u}(n mod N_{ZC}^{RS}), 0≦n≦M_{sc}^{RS}−1 Expression (8)

That is, when the sequence with the sequence length N^{RS}_{ZC} is input, the cyclic extender 403 extends the input sequence to a sequence length M^{RS}_{sc}, and outputs the sequence. For example, in the example of Table 1, by applying Expression (7) to Expression (8), a sequence is obtained like the following expression.

$$\begin{matrix} [ Math . 9 ] & \\ \{ \begin{matrix}{r}_{0} = [ \begin{matrix}{x}_{q} ( 24 ) & {x}_{q} ( 25 ) & … & {x}_{q} ( 30 ) & {x}_{q} ( 0 ) & … & {x}_{q} ( 28 )\end{matrix} ] \\ {r}_{1} = [ \begin{matrix}{x}_{q} ( 17 ) & {x}_{q} ( 18 ) & … & {x}_{q} ( 30 ) & {x}_{q} ( 0 ) & … & {x}_{q} ( 21 )\end{matrix} ] \\ {r}_{2} = [ \begin{matrix}{x}_{q} ( 5 ) & {x}_{q} ( 6 ) & … & {x}_{q} ( 30 ) & {x}_{q} ( 0 ) & … & {x}_{q} ( 9 )\end{matrix} ]\end{matrix} & Expression ( 9 )\end{matrix}$$

The size of each vector is 1×M^{RS}_{sc}. The obtained output of the cyclic extender 403 is input to the time domain cyclic shifter 404.

The time domain cyclic shifter 404 performs time domain cyclic shift for the input rᵤ(n) based on the following expression.

[Math. 10]

rᵤ^{(α)}(n)=exp(jαᵤn)rᵤ(n) Expression (10)

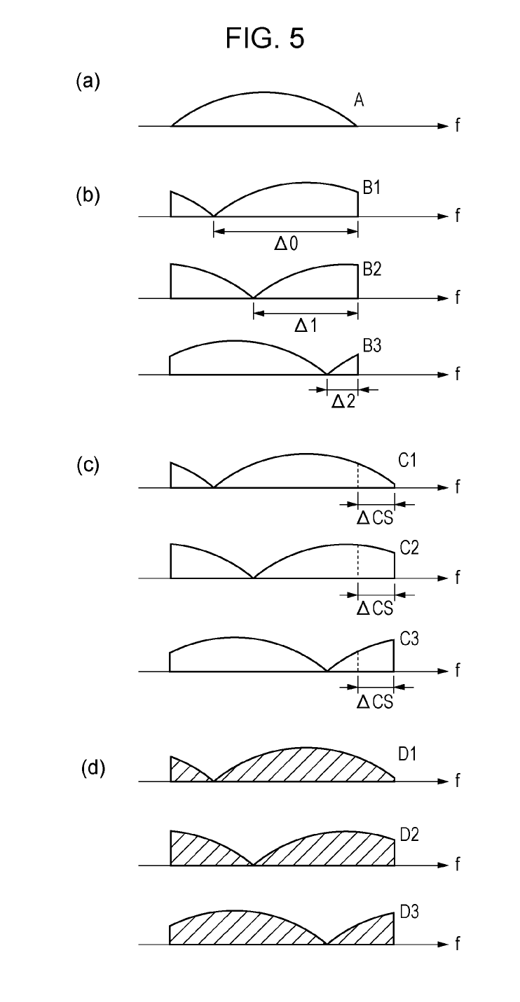

FIGS. 5(a), 5(b), 5(c), and 5(d) are illustrations schematically showing respective outputs of the ZC sequence generator 401, the frequency domain cyclic shifter 402, the cyclic extender 403, and the time domain cyclic shifter 404.

FIG. 5(a) is an illustration schematically showing an output A of the ZC sequence generator 401. The horizontal axis plots the frequency point f. The total number of frequency points in this case is, for example, 31.

FIG. 5(b) is an illustration schematically showing outputs B1, B2, and B3 of the frequency domain cyclic shifter 402. The outputs B1, B2, and B3 indicate three ZC sequences after the cyclic shift to be allocated to the respective paths of the 0th to 2nd transmit antennas. The cyclic shift amounts in this case are Δ₀=24, Δ₁=17, and Δ₂=5 from above in FIG. 5(b) as described above, and the total number of frequency points is 31.

FIG. 5(c) is an illustration schematically showing respective outputs of the cyclic extender 403, and indicates cyclic extension ZC sequences C1 to C3 to be allocated to the respective paths of the 0th to 2nd transmit antennas. The number of frequency points at the extension portion is indicated by Δ_{CS}. The total number of frequency points in this case is 36, and Δ_{CS}=5.

FIG. 5(d) is an illustration schematically showing respective outputs of the time domain cyclic shifters 404. Hatching with oblique lines indicates ZC sequences D1 to D3 after the time domain cyclic shift. The total number of frequency points in this case is 36.

As described above, the cyclic shift amount αᵤ for each transmit antenna may be notified as the control information from the base station 102 for each of the transmit antennas 209-0 to 209-Nₜ−1. Alternatively, only a cyclic shift amount for any of the transmit antennas (for example, the 0th transmit antenna) may be notified from the base station 102, and cyclic shift amounts of the other transmit antennas may be indirectly obtained.

In this embodiment, a cyclic shift in the time domain is equivalently applied by Expression (10) by using that the cyclic shift in the time domain is the linear phase offset in the frequency domain. However, a cyclic shift may be provided on the DMRS after IFFT in the OFDM signal generators 207-0 to 207-Nₜ−1. The ZC sequence is used as a sequence of DMRS. However, the present invention is not limited thereto. A sequence, such as an M sequence or a Gold sequence, may be used, and control may be provided so that the same spectrum is transmitted from respective transmit antennas even with frequencies of overlap allocation.

The output of the time domain cyclic shifter 404 is input as the output of the DMRS generator 212 (FIG. 2), to the DMRS multiplexers 205-0 to 205-Nₜ−1. In the DMRS multiplexers 205-0 to 205-Nₜ−1, the output of the DMRS generator 212 (FIG. 2) occupies the 4th and 11th symbols among the 14 symbols in the single subframe, for each of the paths of the transmit antennas 209-0 to 209-Nₜ−1.

The outputs of the DMRS multiplexers 205-0 to 205-Nₜ−1 are input to the mapping units 206-0 to 206-Nₜ−1.

The mapping units 206-0 to 206-Nₜ−1 provide allocation for frequency arrangements with good channel characteristics for the respective transmit antennas, in response to an instruction from the base station 102.

This frequency allocation is performed by selecting the same, separate, or partly overlapped frequency points with regard to the correlation among the plurality of transmit antennas. Described below is a case in which partly overlapped frequency points are selected.

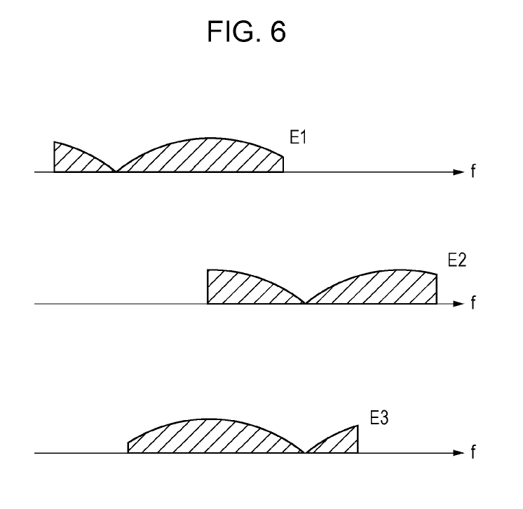

FIG. 6 is an illustration schematically showing outputs E1 to E3 of the mapping units 206-0 to 206-2 when the number of transmit antennas is three, and the frequency points are allocated in accordance with Table 1. The horizontal axis plots the frequency point f. The outputs E1 to E3 have spectra that seem to be mutually the same at overlap portions on a frequency point. The total number of frequency points occupied by each output is 36.

The outputs of the mapping units 206-0 to 206-Nₜ−1 are input to the OFDM signal generators 207-0 to 207-Nₜ−1.

The OFDM signal generators 207-0 to 207-Nₜ−1 first perform multiplexing of the sounding reference signal SRS as required. The SRS generator 213 creates a SRS under control with a signal from the control information receiver 211, and supplies the SRS together with allocation information to the OFDM signal generators 207-0 to 207-Nₜ−1.

Then, the OFDM signal generators 207-0 to 207-Nₜ−1 each apply the N_{FFT}-point IFFT (inverse fast Fourier transform) for a SC-FDMA symbol, and hence performs conversion from a frequency domain signal to a time domain signal. Then, a cyclic prefix CP corresponding to a guard time is inserted into the converted SC-FDMA symbol. SC-FDMA symbols after CPs are inserted are output to the transmitters 208-0 to 208-Nₜ−1.

The transmitters 208-0 to 208-Nₜ−1 then perform D/A (digital-analog) conversion, orthogonal modulation, analog filtering, upconversion to a carrier frequency from a baseband, etc., on the symbols. Then, radio frequency signals that carry the SC-FDMA symbols after the insertion of the CPs are transmitted from the transmit antennas 209-0 to 209-Nₜ−1 to the base station 102.

As described above, the signals transmitted from the terminal 101 propagate through the radio channels and are received by a number Nᵣ of receive antennas of the base station 102.

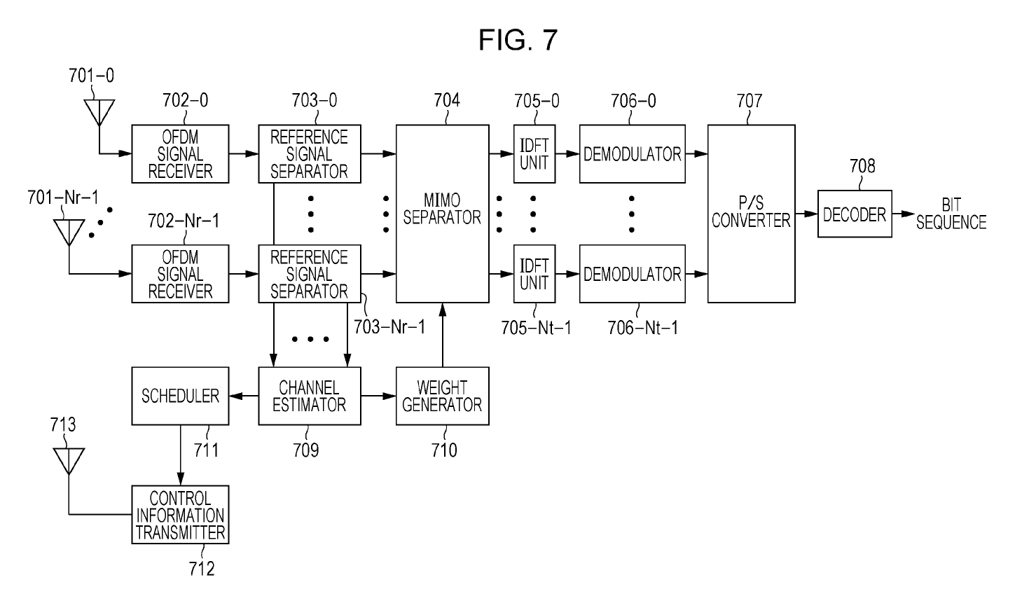

FIG. 7 is a brief block diagram showing a configuration of the base station 102.

The base station 102 includes receive antennas 701-0 to 701-Nᵣ−1, OFDM signal receivers 702-0 to 702-Nᵣ−1, reference signal separators 703-0 to 703-Nᵣ−1, a MIMO separator 704, IDFT units 705-0 to 705-Nₜ−1, demodulators 706-0 to 706-Nₜ−1, a P/S converter 707, a decoder 708, a channel estimator 709, a weight generator 710, a scheduler 711, a control information transmitter 712, and a transmit antenna 713.

Described below is a case in which the receive antennas 701-0 to 701-Nᵣ−1 of the base station 102 are used to receive signals transmitted from the terminal 101 by single carrier transmission.

Other known configuration included in the base station 102 is omitted in FIG. 7 for easier understanding of the description. This is also applied to the other embodiments.

Signals received by the number Nᵣ of receive antennas 701-0 to 701-Nᵣ−1 are respectively input to the OFDM signal receivers 702-0 to 702-Nᵣ−1. The OFDM signal receivers 702-0 to 702-Nᵣ−1 each perform downconversion from a carrier frequency to a baseband signal, analog filtering, A/D (analog-digital) conversion, deletion of a cyclic prefix CP for each SC-FDMA symbol, then apply the N_{FFT}-point fast Fourier transform (FFT), and perform conversion from a time domain signal to a frequency domain signal.

The frequency domain signals are input to the reference signal separators 703-0 to 703-Nᵣ−1.

The reference signal separators 703-0 to 703-Nᵣ−1 each separate the demodulation reference signals DMRSs at the 4th (#4) and 11th (#11) symbols of the single subframe in the middle row in FIG. 3, and the sounding reference signal SRS if the SRS is inserted into the 14th (#14) symbol, and input the reference signal to the channel estimator 709. Also, the reference signal separators 703-0 to 703-Nᵣ−1 input the 1st to 3rd, 5th to 10th, 12th, and 13th data SC-FDMA symbols of the single subframe in the middle row in FIG. 3 and the data SC-FDMA symbol if the data SC-FDMA symbol is inserted into the 14th symbol, to the MIMO separator 704.

In the channel estimator 709 estimates radio channels (phase and amplitude of a channel constant of a radio channel) between the respective transmit antennas of the terminal 101 and the receive antenna of the base station 102 in the band in which the data signal is transmitted, by using the demodulation reference signal DMRS. The obtained channel estimation value is input to the weight generator 710.

Also, the channel estimator 709 uses the sounding reference signal SRS, and performs estimation on channel quality between the transmit antennas 209-0 to 209-Nₜ−1 of the terminal 101 and the receive antennas 701-0 to 701-Nᵣ−1 of the base station 102 in not only the band in which the data signal is transmitted but also the entire system band (estimation on channel quality by using only an amplitude value or a power value of SRS). The channel quality estimation value in the entire system band estimated by the channel estimator 709 is input to the scheduler 711.

The scheduler 711 determines frequency allocation to the transmit antennas of each terminal 101 for the next transmission opportunity, and inputs the allocation as allocation information to the control information transmitter 712. The control information transmitter 712 transmits the input allocation information, and information relating to, for example, a modulation scheme and a code rate, as control information to each terminal 101 through the transmit antenna 713.

Meanwhile, the MIMO separator 704 multiplies the signals input from the reference signal separators 703-0 to 703-Nᵣ−1 with a weight input from the weight generator 710. Thus, the streams are separated, and the streams are respectively input to the IDFT units 705-0 to 705-Nₜ−1.

The weight generator 710 uses the channel estimation value input from the channel estimator 709, hence generates a ZF (Zero Forcing) weight or a MMSE (Minimum Mean Square Error) weight, and inputs the generated value to the MIMO separator 704. The channel estimation method by the channel estimator 709 is described later.

The IDFT units 705-0 to 705-Nₜ−1 perform the inverse discrete Fourier transform (IDFT), so that frequency domain signals are converted into time domain signals, and input the converted signals to the demodulators 706-0 to 706-Nₜ−1. The demodulators 706-0 to 706-Nₜ−1 convert the input time domain signals into bit sequences based on a modulation scheme that is performed at the transmission side. The outputs of the demodulators 706-0 to 706-Nₜ−1 are input to the P/S converter 707, parallel-serial conversion is performed, and the converted outputs are input to the decoder 708. The decoder 708 performs error correction decoding and outputs a bit sequence of received data.

The MIMO separator 704 in the base station 102 according to this embodiment has a configuration that separates the signals by linear filtering. However, MLD (maximum likelihood detection), iterative processing such as PIC (parallel interference cancellation), or other separation method may be used.

Here, the estimation method for the channel estimation value that is input by the channel estimator 709 to the weight generator 710 is described. The DMRS generator 212 (FIG. 2) applies different cyclic shifts a respectively to the transmit antennas. As shown in FIG. 6, the same spectrum is transmitted at the partly overlapped frequency points.

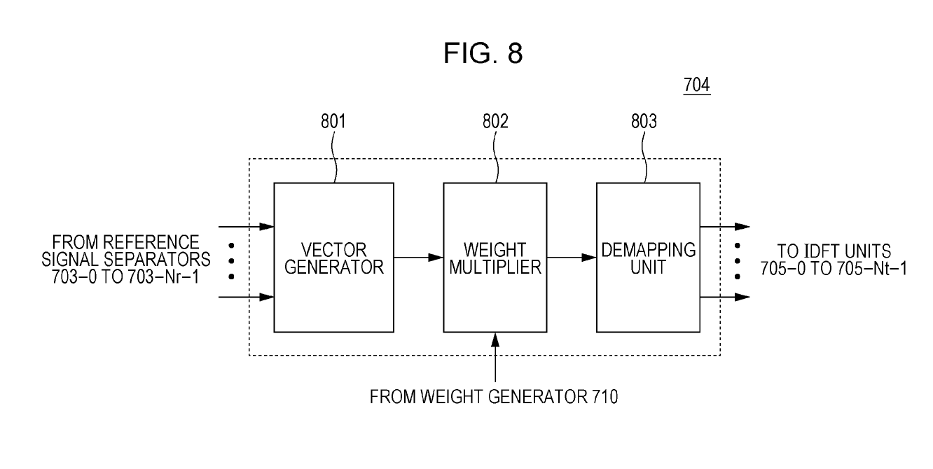

FIG. 8 is a block diagram showing the detail of a configuration of the MIMO separator 704.

The MIMO separator 704 includes a vector generator 801, a weight multiplier 802, and a demapping unit 803.

Data signals input from the reference signal separators 703-0 to 703-Nᵣ−1 (FIG. 7) are input to the vector generator 801. The vector generator 801 couples the inputs from the reference signal separators 703-0 to 703-Nᵣ−1 for each of the subcarriers, and generates a vector of Nᵣ×1. That is, inputs R₀(k) to R_{Nr-1}(k) from the reference signal separators 703-0 to 703-Nᵣ−1 with a k-th frequency (k-th subcarrier) are coupled, and a vector R(k) is generated as follows.

[Math. 11]

R(k)=[R₀(k)R₁(k) . . . R_{Nr-1}(k)]^{T} Expression (11)

Here, T represents transposition processing for the vector.

The vector R(k) for each frequency generated by the vector generator 801 is input to the weight multiplexer 802. The weight multiplexer 802 multiplies the vector for each frequency k input from the vector generator 801 with a weight matrix for each frequency input from the weight generator 710 (FIG. 7), from the left. The size of a weight is Nₜ×Nᵣ, and is expressed as follows.

$$\begin{matrix} [ Math . 12 ] & \\ w ( k ) = [ \begin{matrix}{w}_{0 , 0} ( k ) & {w}_{0 , 1} ( k ) & … & {w}_{0 , Nr - 1} ( k ) \\ {w}_{1 , 0} ( k ) & {w}_{1 , 1} ( k ) & … & {w}_{1 , Nr - 1} ( k ) \\ ⋮ & ⋮ & ⋱ & ⋮ \\ {w}_{Nt - 1 , 0} ( k ) & {w}_{Nt - 1 , 1} ( k ) & … & {w}_{Nt - 1 , Nr - 1} ( k )\end{matrix} ] & Expression ( 12 )\end{matrix}$$

The weight multiplier 802 calculates a vector _{y}(k) of Nₜ×1 obtained by multiplication of Expression (13) for each frequency k, and inputs the calculated value to the demapping unit 803.

$$\begin{matrix}[ Math . 13 ] & \\ \begin{matrix}y ( k ) = w ( k ) R ( k ) \\ = {[ \begin{matrix}{y}_{0} ( k ) & {y}_{1} ( k ) & … & {y}_{Nt - 1} ( k )\end{matrix} ]}^{T}\end{matrix} & Expression ( 13 )\end{matrix}$$

The demapping unit 803 extracts a subcarrier (frequency point or orthogonal frequency) that is used for transmission of each stream in accordance with each input vector y(k), and outputs the subcarrier to the IDFT units 705-0 to 705-Nₜ−1.

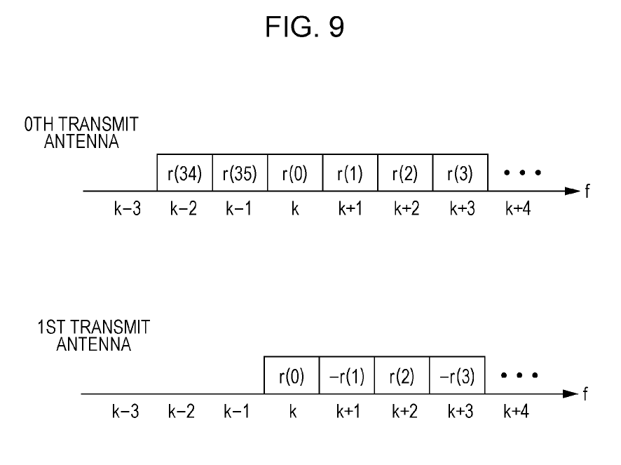

FIG. 9 indicates an example of outputs from the mapping units 206-0 to 206-1 (FIG. 2), for example, when the number of transmit antennas is two (when the 0th transmit antenna and the 1st transmit antenna are present). The upper row in FIG. 9 indicates an output of the mapping unit 206-0 in the path of the 0th transmit antenna, and the lower low indicates an output of the mapping unit 206-1 in the path of the 1st transmit antenna. The horizontal axis plots frequency points k−3, k−2, k−1, k, k+1, k+2, k+3, k+4, . . . . In the path of the 0th transmit antenna, r(34), r(35), r(0), r(1), r(2), r(3), . . . , which are a ZC sequence obtained by applying a cyclic extension, a frequency domain cyclic shift, and a time domain cyclic shift of α₀=0 to frequency points started from k−2 are allocated. In the path of the 1st transmit antenna, r(0), −r(1), r(2), −r(3), . . . , which are a ZC sequence obtained by applying a cyclic extension, a frequency domain cyclic shift, and a time domain cyclic shift of α₁=7 to frequency points started from k are allocated.

In the case of cyclic shift α₀=0 of the 0th transmit antenna and cyclic shift α₁=π of the 1st transmit antenna, reception signals Rᵥ(k) and Rᵥ(k+1) at the k-th frequency point and the k+1-th frequency point of a v-th receive antenna are expressed by the following expression.

$$\begin{matrix}[ Math . 14 ] & \\ \{ \begin{matrix}{R}_{v} ( k ) = {H}_{v , 0} ( k ) r ( 0 ) + {H}_{v , 1} ( k ) r ( 0 ) \\ {R}_{v} ( k + 1 ) = {H}_{v , 0} ( k + 1 ) r ( 1 ) - {H}_{v , 1} ( k + 1 ) r ( 1 )\end{matrix} & Expression ( 14 )\end{matrix}$$

Here, H_{v,u}(k) is a channel gain at the k-th frequency point between the u-th transmit antenna and the v-th receive antenna.

When, the channel does not have high frequency selectivity and hence frequency variation at an adjacent frequency point is negligible, and when H_{v,u}(k)=H_{v,u}(k+1) is established, Expression (14) can be modified as follows.

$$\begin{matrix}[ Math . 15 ] & \\ \{ \begin{matrix}{R}_{v} ( k ) / r ( 0 ) = {H}_{v , 0} ( k ) + {H}_{v , 1} ( k ) \\ {R}_{v} ( k + 1 ) / r ( 1 ) = {H}_{v , 0} ( k ) - {H}_{v , 1} ( k )\end{matrix} & Expression ( 15 )\end{matrix}$$

By performing addition or subtraction for the two expressions in Expression (15), the following expression can be obtained.

$$\begin{matrix}[ Math . 16 ] & \\ \{ \begin{matrix}{H}_{v , 0} ( k ) = ( {R}_{v} ( k ) / r ( 0 ) + {R}_{v} ( k + 1 ) / r ( 1 ) ) / 2 \\ {H}_{v , 1} ( k ) = ( {R}_{v} ( k ) / r ( 0 ) - {R}_{v} ( k + 1 ) / r ( 1 ) ) / 2\end{matrix} & Expression ( 16 )\end{matrix}$$

As described above, by applying the different cyclic shifts to the respective transmit antennas by using the same spectrum with each frequency, the channel estimator can estimate the channel gain with respect to each transmit antenna with high accuracy without an increase in scale or an increase in power consumption of the device because of the use of complicated calculation. Since an error rate performance of data is improved, throughput can be increased.

### Second Embodiment

In the first embodiment, the use bandwidth is the same when allocation is performed to each transmit antenna. However, scheduling at the base station can be flexible if the use bandwidth is allowed to be different for each transmit antenna. Hence, system throughput can be increased.

Therefore, described in this embodiment is a transmission method of a demodulation reference signal DMRS when the transmit antennas have respectively different allocation frequency bandwidths.

Hereinafter, description is given such that reference sign 101a is applied to a terminal and 102a is applied to a base station in this embodiment.

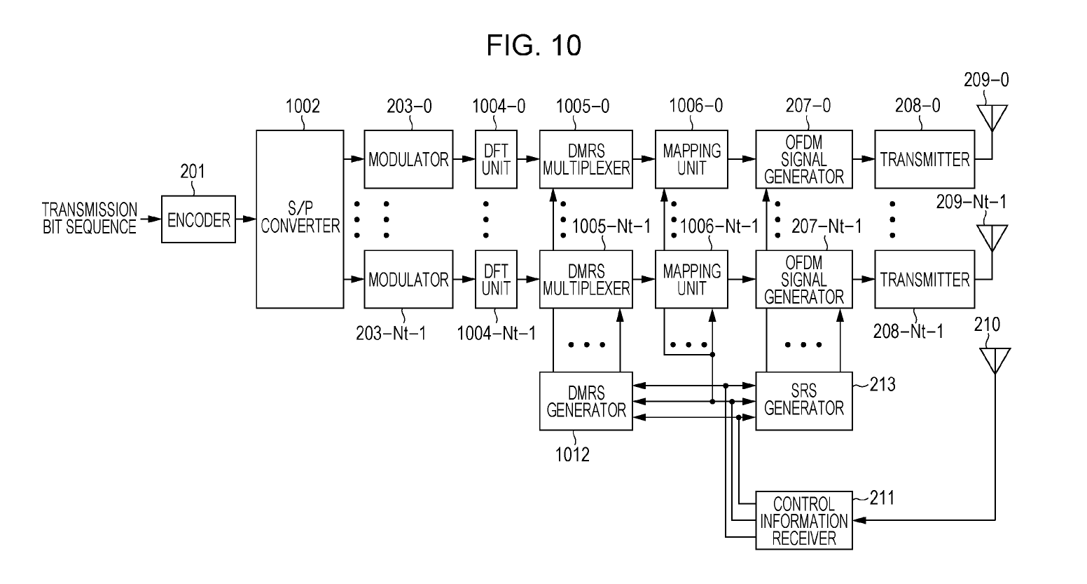

FIG. 10 is a brief block diagram showing a configuration of the terminal 101a according to the second embodiment.

The terminal 101a includes an encoder 201, a S/P converter 1002, modulators 203-0 to 203-Nₜ−1, DFT units 1004-0 to 1004-Nₜ−1, DMRS multiplexers 1005-0 to 1005-Nₜ−1, mapping units 1006-0 to 1006-Nₜ−1, OFDM signal generators 207-0 to 207-Nₜ−1, transmitters 208-0 to 208-Nₜ−1, transmit antennas 209-0 to 209-Nₜ−1, a receive antenna 210, a control information receiver 211, a DMRS generator 1012, and a SRS generator 213.

When the configuration of the terminal 101a according to the second embodiment is compared with the configuration of the terminal 101 (FIG. 2) according to the first embodiment, the S/P converter 1002, the DFT units 1004-0 to 1004-Nₜ−1, the DMRS multiplexers 1005-0 to 1005-Nₜ−1, the mapping units 1006-0 to 1006-Nₜ−1, and the DMRS generator 1012 of the former embodiment are respectively different from the S/P converter 202, the DFT units 204-0 to 204-Nₜ−1, the DMRS multiplexers 205-0 to 205-Nₜ−1, the mapping units 206-0 to 206-Nₜ−1, and the DMRS generator 212. However, other configuration (the encoder 201, the modulators 203-0 to 203-Nₜ−1, the OFDM signal generators 207-0 to 207-Nₜ−1, the transmitters 208-0 to 208-Nₜ−1, the transmit antennas 209-0 to 209-Nₜ−1, the receive antenna 210, the control information receiver 211, and the SRS generator 213) is the same, and the description thereof is omitted.

In the first embodiment, the respective transmit antennas have the equal allocation frequency bandwidth. Hence, the S/P converter 202 (FIG. 2) inputs the encoded bits evenly to all layers (the paths of the transmit antennas).

In this embodiment, the number of encoded bits to be input to the respective modulators 203-0 to 203-Nₜ−1 by the S/P converter is different in accordance with allocation information notified from the base station 102a. Also, the DFT units 1008-0 to 1008-Nₜ−1 are also different respectively for the transmit antennas in accordance with allocation frequency bandwidths.

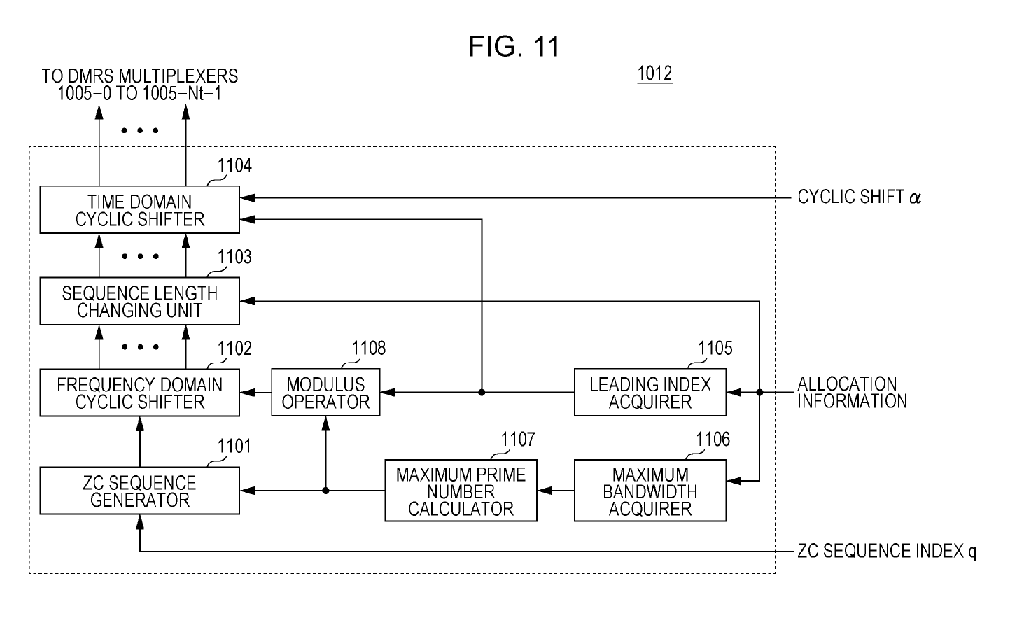

Here, the DMRS generator 1012 is described in detail with reference to FIG. 11.

FIG. 11 shows an example of a configuration of the DMRS generator 1012.

The DMRS generator 1012 includes a ZC sequence generator 1101, a frequency domain cyclic shifter 1102, a sequence length changing unit 1103, a time domain cyclic shifter 1104, a maximum bandwidth acquirer 1106, a leading index acquirer 1105, a maximum prime number calculator 1107, and a modulus operator 1108.

First, allocation information input from the control information receiver 211 (FIG. 10) is input to the maximum bandwidth acquirer 1106, the leading index acquirer 1105, and the sequence length changing unit 1103.

The maximum bandwidth acquirer 1106 compares allocation bandwidths M^{RS}_{sc} in the respective transmit antennas 209-0 to 209-Nₜ−1 with each other from the input allocation information, acquires the widest allocation bandwidth M^{RS}_{SC}, and inputs the widest allocation bandwidth M^{RS}_{sc} to the maximum prime number calculator 1107.

For example, a case in which the number of transmit antennas is three is described.

In the case of allocation as shown in Table 2, bandwidths M^{RS}ᵤ of a 0th transmit antenna to a 2nd transmit antenna are respectively M^{RS}₀=4, M^{RS}₁=36, and M^{RS}_{b=48}. Accordingly, the widest allocation bandwidth M^{RS}_{sc}=48 becomes the output of the maximum bandwidth acquirer 1106.

In this embodiment, the widest allocation bandwidth is M^{RS}_{sc}. However, for example, the narrowest allocation bandwidth, an allocation bandwidth of the 0th transmit antenna, or a fixed value independent from allocation may be set to M^{RS}_{sc}. That is, any value may be the allocation bandwidth M^{RS}_{sc} to be input to the maximum prime number calculator 1107 as long as the value is previously defined in both the transmitter and receiver.

TABLE 2

| | Allocation |
|---|---|
| 0th transmit antenna | 60 to 83 |
| 1st transmit antenna | 36 to 71 |
| 2nd transmit antenna | 48 to 95 |

The maximum prime number calculator 1107 calculates a maximum prime number N^{RS}_{ZC} that does not exceed M^{RS}_{sc} from the input bandwidth M^{RS}_{sc}, and inputs the calculated value to the ZC sequence generator 1101 and the modulus operator 1108. Since M^{RS}_{sc}=48 in the example of Table 2, N^{RS}_{ZC}=47 is obtained.

The ZC sequence generator 1101 generates a ZC sequence x_{q}(m) (0≦m≦N^{RS}_{ZC}−1) with a length N^{RS}_{ZC} by the ZC sequence index q output from the control information receiver 211 (FIG. 10), the N^{RS}_{ZC} input from the maximum prime number calculator 1107, and Expression (2), and inputs the generated value to the frequency domain cyclic shifter 1102.

Also, the leading index acquirer 1105 acquires a frequency index k_{TOP,u} at the leading end of frequency allocation for a u-th transmit antenna from the allocation information input from the control information receiver 211 (FIG. 10), and inputs the acquired value to the modulus operator 1108 and the time domain cyclic shifter 1104. For example, in the case of allocation as shown in Table 2, k_{TOP,0}=60, k_{TOP,1}=36, and k_{TOP,2}=48, which are frequency indices at the leading ends of the 0th to 2nd transmit antennas are extracted, and are input to the modulus operator 1108 and the time domain cyclic shifter 1104.

The modulus operator 1108 calculates a cyclic shift amount Δᵤ in the frequency domain of each transmit antenna by the following expression, based on the index k_{TOP,u} at the leading end at each transmit antenna input from the leading index acquirer 1105 and the N^{RS}_{ZC} input from the maximum prime number calculator 1107.

[Math. 17]

Δᵤ=k_{TOP,u} mod N_{ZC}^{RS} Expression (17)

For example, in the case of Table 2, since N^{RS}_{ZC}=47, Δ₀=13, Δ₁=36, and Δ₂=1 are obtained.

A cyclic shift amount Δᵤ in the frequency domain for each transmit antenna calculated by the modulus operator 1108 is input to the frequency domain cyclic shifter 1102.

The frequency domain cyclic shifter 1102 calculates a sequence x_{q,u}(m) for each transmit antenna by using a sequence x_{q}(m) with a length N^{RS}_{ZC} input from the ZC sequence generator 1101 and Δᵤ input from the modulus operator 1108, based on the following expression.

[Math. 18]

x_{q,u}(m)=x_{q}((m+Δᵤ)mod N_{ZC}^{RS}), 0≦m≦N_{ZC}^{RS}−1 Expression (18)

That is, the frequency domain cyclic shifter 1102 performs processing of applying a cyclic shift, which is different for each transmit antenna, to the ZC sequence. The cyclic shift of the frequency domain cyclic shifter 1102 is a cyclic shift in the frequency domain, and is different from a cyclic shift in the time domain.

For example, in the case of allocation in Table 2, a sequence vector x_{q,u} of each transmit antenna is as follows.

$$\begin{matrix} [ Math . 19 ] & \\ \{ \begin{matrix}{x}_{q , 0} = [ \begin{matrix}{x}_{q} ( 13 ) & {x}_{q} ( 14 ) & … & {x}_{q} ( 46 ) & {x}_{q} ( 0 ) & … & {x}_{q} ( 12 )\end{matrix} ] \\ {x}_{q , 1} = [ \begin{matrix}{x}_{q} ( 36 ) & {x}_{q} ( 37 ) & … & {x}_{q} ( 46 ) & {x}_{q} ( 0 ) & … & {x}_{q} ( 35 )\end{matrix} ] \\ {x}_{q , 2} = [ \begin{matrix}{x}_{q} ( 1 ) & {x}_{q} ( 2 ) & … & {x}_{q} ( 46 ) & {x}_{q} ( 0 )\end{matrix} ]\end{matrix} & Expression ( 19 )\end{matrix}$$

The sizes of three vectors at the left sides of Expression (19) are each 1×N^{RS}_{ZC}.

The sequence for each transmit antenna calculated by the frequency domain cyclic shifter 1102 is input to the sequence length changing unit 1003. The sequence length changing unit 1103 acquires a use bandwidth M^{RS}ᵤ for each transmit antenna from the input allocation information, and changes the sequence length to an allocation bandwidth for each transmit antenna, by using the input x_{q,u}(m) from the frequency domain cyclic shifter 1102 and the following expression.

[Math. 20]

rᵤ(n)=x_{q,u}(n mod N_{ZC}^{RS}), 0≦n≦Mᵤ^{RS}−1 Expression (20)

That is, since the sequence length of the output of the frequency domain cyclic shifter 1102 is N^{RS}_{ZC}, the sequence length changing unit 1103 changes the sequence length so that the sequence length of the u-th transmit antenna becomes the allocation bandwidth M^{RS}ᵤ. For example, in the example of Table 2, by applying Expression (19) to Expression (20), a sequence is obtained like the following expression.

$$\begin{matrix} [ Math . 21 ] & \\ \{ \begin{matrix}{r}_{0} = [ \begin{matrix}{x}_{q} ( 13 ) & {x}_{q} ( 14 ) & … & {x}_{q} ( 36 )\end{matrix} ] \\ {r}_{1} = [ \begin{matrix}{x}_{q} ( 36 ) & {x}_{q} ( 37 ) & … & {x}_{q} ( 46 ) & {x}_{q} ( 0 ) & … & {x}_{q} ( 24 )\end{matrix} ] \\ {r}_{2} = [ \begin{matrix}{x}_{q} ( 1 ) & {x}_{q} ( 2 ) & … & {x}_{q} ( 46 ) & {x}_{q} ( 0 ) & {x}_{q} ( 1 )\end{matrix} ]\end{matrix} & Expression ( 21 )\end{matrix}$$

The obtained output of the sequence length changing unit 1103 is input to the time domain cyclic shifter 1104.

The time domain cyclic shifter 1104 provides a time domain cyclic shift for the input rᵤ(n) based on the following expression.

[Math. 22]

rᵤ^{(α)}(n)=exp(jαᵤn)rᵤ(n) Expression (22)

The output of the time domain cyclic shifter 1104 is input as the output of the DMRS generator 1012 (FIG. 10), to the DMRS multiplexers 1005-0 to 1005-Nₜ−1. In the DMRS multiplexers 1005-0 to 1005-Nₜ−1, the output of the DMRS generator 1012 occupies the 4th and 11th symbols among the 14 symbols in the single subframe, for each of the paths of the transmit antennas 209-0 to 209-Nₜ−1.

The outputs of the DMRS multiplexers 1005-0 to 1005-Nₜ−1 are input to the mapping units 1006-0 to 1006-Nₜ−1.

The mapping units 1006-0 to 1006-Nₜ−1 provide allocation for frequency arrangements with good channel characteristics for the respective transmit antennas, in response to an instruction from the base station 102a.

This frequency allocation is performed by selecting a frequency point from the three cases of the same, separate, and partly overlapped frequency points, with regard to the correlation among the plurality of transmit antennas. Described below is a case in which partly overlapped frequency points are selected.

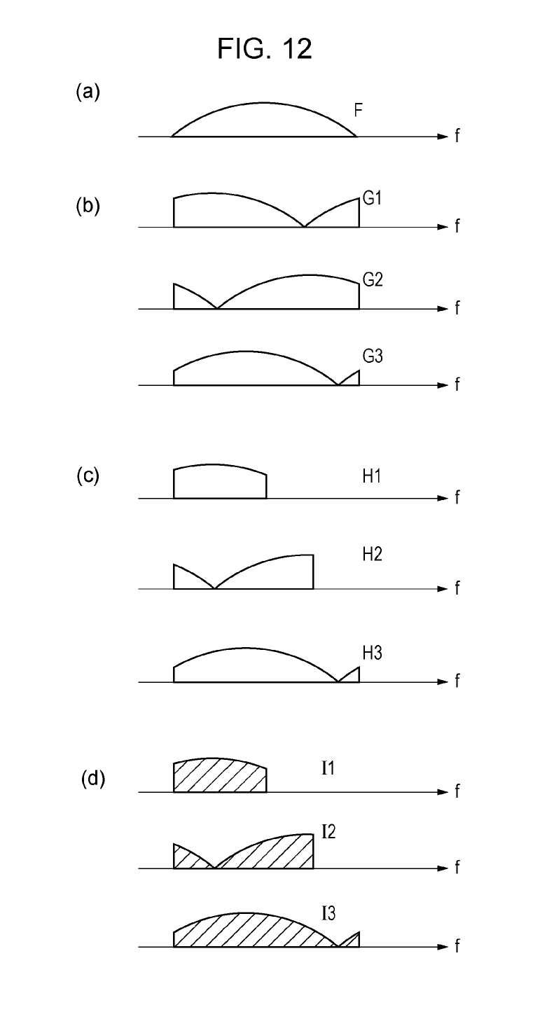

FIGS. 12(a), 12(b), 12(c), and 12(d) are illustrations schematically showing respective outputs of the ZC sequence generator 1101, the frequency domain cyclic shifter 1102, the sequence length changing unit 1103, and the time domain cyclic shifter 1104 in the case of Table 2. The horizontal axis plots the frequency point f.

FIG. 12(a) is an illustration schematically showing an output F of the ZC sequence generator 1001. The horizontal axis plots the frequency point. The total number of frequency points in this case is, for example, 47.

FIG. 12(b) is an illustration schematically showing outputs G1, G2, and G3 of the frequency domain cyclic shifter 1102. The outputs G1, G2, and G3 indicate three ZC sequences after the cyclic shift to be allocated to the respective paths of the 0th to 2nd transmit antennas. The cyclic shift amounts in this case are Δ₀=13, Δ₁=36, and Δ₂=1 from above in FIG. 12(b) as described above, and the total number of frequency points is 47.

FIG. 12(c) is an illustration schematically showing respective outputs of the sequence length changing unit 1103, and indicates sequences H1 to H3 after the change of the sequence lengths to be allocated to the respective paths of the 0th to 2nd transmit antennas. The sequence H1 has a sequence length of 24, the sequence length H2 has a sequence length of 36, and the sequence length H3 has a sequence length of 48.

FIG. 12(d) is an illustration schematically showing respective outputs of the time domain cyclic shifters 1104. Hatching with oblique lines indicates sequences I1 to I3 after the time domain cyclic shift. The sequence I1 has a sequence length of 24, the sequence length I2 has a sequence length of 36, and the sequence length I3 has a sequence length of 48. Also, cyclic shift amounts αᵤ may respectively use 0, 2π/3, and 4π/3 for the paths of the 0th to 2nd transmit antennas. The value of αᵤ is not limited thereto.

The output of the time domain cyclic shifter 1104 is input as the output of the DMRS generator 1012 (FIG. 10), to the DMRS multiplexers 1005-0 to 1005-Nₜ−1. In the DMRS multiplexers 1005-0 to 1005-Nₜ−1, the output of the DMRS generator 1012 (FIG. 10) occupies the 4th and 11th symbols among the 14 symbols in the single subframe, for each of the paths of the transmit antennas 209-0 to 209-Nₜ−1.

The outputs of the DMRS multiplexers 1005-0 to 1005-Nₜ−1 are input to the mapping units 1006-0 to 1006-Nₜ−1.

The mapping units 1006-0 to 1006-Nₜ−1 provide allocation for frequency arrangements with good channel characteristics for the respective transmit antennas, in response to an instruction from the base station 102a.

This frequency allocation is performed by selecting the same, separate, or partly overlapped frequency points with regard to the correlation among the plurality of transmit antennas. Described below is a case in which partly overlapped frequency points are selected.

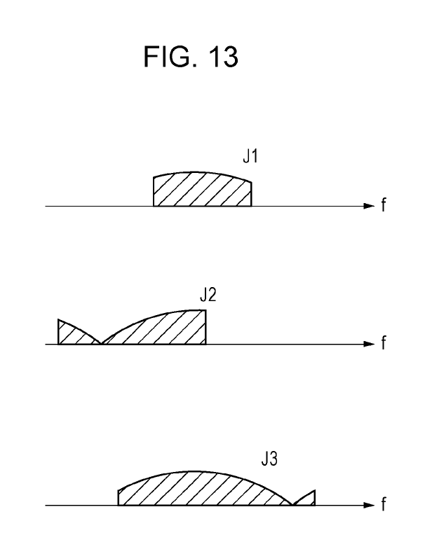

FIG. 13 is an illustration schematically showing outputs J1 to J3 of the mapping units 1006-0 to 1006-2 when the number of transmit antennas is three, and the frequency points are allocated in accordance with Table 2. The horizontal axis plots the frequency point f. The outputs J1 to J3 have spectra that seem to be mutually the same at overlap portions on a frequency point. The total numbers of frequency points respectively occupied by the outputs are 24, 36, and 48.

In FIG. 10, processing similar to the first embodiment is performed in other blocks other than the blocks described above.

A configuration of the base station device according to the second embodiment is similar to the configuration of the base station device according to the first embodiment (FIG. 7), and the latter configuration may be used with appropriate modification in design. A configuration of a MIMO separator used in the base station device according to the second embodiment is also similar to the configuration of the MIMO separator 704 in the base station device according to the first embodiment (FIG. 8), and the latter configuration may be used with appropriate modification in design.

Since the DMRS generator 1012 is used as described above, even in a SU-MIMO system with different allocation bandwidths respectively for the transmit antennas, the same spectrum can be transmitted from the respective transmit antennas with frequencies of overlap allocation of the respective transmit antennas. As a result, by combining known techniques such as cyclic shift in the time domain, even in a SU-MIMO system with different allocation bandwidths for the respective transmit antennas, the channel estimator can estimate the channel gains with respect to the respective transmit antennas with high accuracy. Since an error rate performance of data is improved, throughput can be increased.

### Third Embodiment

The first embodiment and the second embodiment gives the description when the number Nₜ of transmit antennas is the same as the rank R.

In this embodiment, description is given for a case in which a rank R is smaller than a number Nₜ of transmit antennas (Nₜ>R). Hereinafter, description is given such that reference sign 101b is applied to a terminal and 102b is applied to a base station in this embodiment.

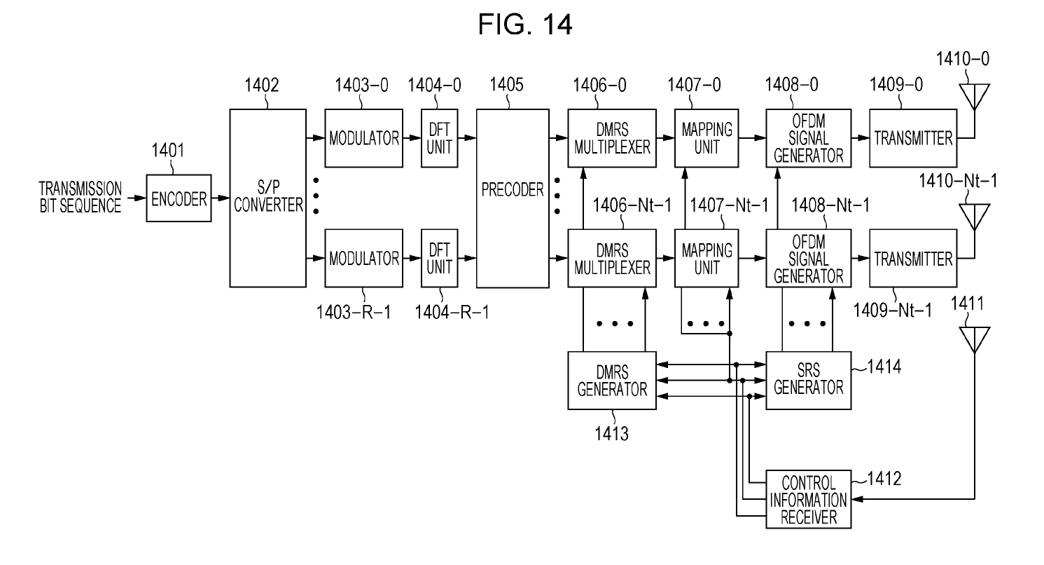

FIG. 14 is a brief block diagram showing a configuration of the terminal 101b according to the third embodiment.

The terminal 101b includes an encoder 1401, a S/P converter 1402, modulators 1403-0 to 1403-R−1, DFT units 1404-0 to 1404-R−1, a precoder 1405, DMRS multiplexers 1406-0 to 1406-Nₜ−1, mapping units 1407-0 to 1407-Nₜ−1, OFDM signal generators 1408-0 to 1408-Nₜ−1, transmitters 1409-0 to 1409-Nₜ−1, transmit antennas 1410-0 to 1410-Nₜ−1, a receive antenna 1411, a control information receiver 1412, a DMRS generator 1413, and a SRS generator 1414.

In the configuration of the terminal 101b in FIG. 14, it is assumed that the number of transmit antennas is Nₜ, and the number of simultaneous transmission streams (also called rank or the number of layers) is R.

The encoder 1401 applies error correction encoding to a transmission bit sequence of data, such as audio data, character data, or image data. The output of the encoder 1401 is input to the S/P (serial to parallel) converter 1402. The S/P converter 1402 performs serial-parallel conversion on the input transmission bit sequence to correspond to the number R of simultaneous transmission streams. The output of the S/P converter 1402 is input to the modulators 1403-0 to 1403-R−1. Each modulator converts the input bit sequence into a modulation signal on a symbol basis of, for example, QPSK (quadrature phase shift keying, 4-phase modulation) or 16QAM (quadrature amplitude modulation, 16-value orthogonal amplitude modulation), and outputs the modulation signal. The DFT units 1404-0 to 1404-Nᵣ−1 that perform the N_{DFT}-point discrete Fourier transform apply the discrete Fourier transform (also called DFT) to the outputs of the modulators 1403-0 to 1403-R−1. Hence, time domain signals are converted into frequency domain signals.

The outputs of the DFT units 1404-0 to 1404-R−1 are input to the precoder 1405.

The precoder 1405 multiplies spectra output from the R DFT units 1404-0 to 1404-R−1 with a precoding sequence W of Nₜ×R, from the left. For example, when the transmit antenna number Nₜ=4 and the rank R=3, a sequence W of the following expression is multiplied.

$$\begin{matrix}[ Math . 23 ] & \\ W = \frac{1}{2} [ \begin{matrix}1 & 0 & 0 \\ 0 & 1 & 0 \\ - 1 & 0 & 0 \\ 0 & 0 & 1\end{matrix} ] & Expression ( 23 )\end{matrix}$$

The sequence W of this expression is an example, and other precoding sequence may be used.

In the sequences on the right side of the expression, 0th to 3rd rows respectively correspond to the transmit antennas, and 0th to 2nd columns respectively correspond to the rank.

The precoding sequence to be multiplied may be determined by the terminal 101b, or may be notified by the base station 102b to the terminal 101b as PMI (precoding matrix indicator). In the latter case, the base station 102b selects a precoding sequence from various precoding sequences so that received SINR (signal to interference plus noise power ratio) or the channel capacity becomes the maximum.

For example, when the sequence W in Expression (23) described above is selected, since the number in the 0th column on the 0th row and the number in the 0th column on the 2nd row are not zero, the same sequence is transmitted from the 0th and 2nd transmit antennas. However, in this example, an output of the 2nd transmit antenna is a value obtained by multiplying an output of the 0th transmit antenna with a minus. That is, the output of the second transmit antenna is a value obtained by inverting the phase of the output of the 0th transmit antenna. In the channel state in this case, a predetermined receive antenna of the base station 102 receives the two outputs in the same phase, and as a result, high reception quality can be obtained.

The outputs of the precoder 1405 are input to the DMRS multiplexers 1406-0 to 1406-Nₜ−1.

The DMRS multiplexers 1406-0 to 1406-Nₜ−1 multiplex data signals output from the precoder 1405 on a demodulation reference signal DMRS input from the DMRS generator 1413, and form transmission frames. An example of the transmission frame may be the transmission frame (FIG. 3) already described in the first embodiment.

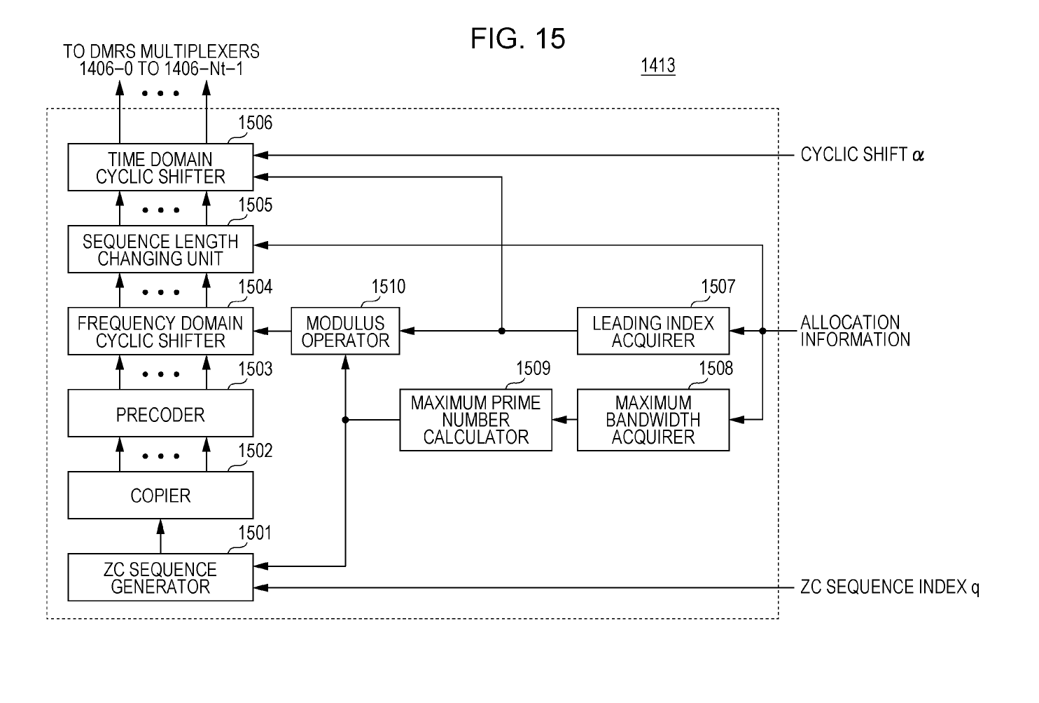

Here, the DMRS generator 1413 is described in detail with reference to FIG. 15.

The DMRS generator 1413 includes a ZC sequence generator 1501, a copier 1502, a precoder 1503, a frequency domain cyclic shifter 1504, a sequence length changing unit 1505, a time domain cyclic shifter 1506, a leading index acquirer 1507, a maximum bandwidth acquirer 1508, a maximum prime number calculator 1509, and a modulus operator 1510.

Allocation information input from the control information receiver 1412 is input to the maximum bandwidth acquirer 1508.

The maximum bandwidth acquirer 1508 compares allocation bandwidths of the respective transmit antennas with each other, acquires the widest allocation bandwidth M^{RS}_{sc}, and inputs the acquired value to the maximum prime number calculator 1509. For example, in the case of allocation in Table 3, since bandwidths M^{RS}ᵤ of a u-th transmit antenna are respectively M^{RS}₀=24, M^{RS}₁=36, M^{RS}₂=24, and M^{RS}₃=48, the widest allocation bandwidth M^{RS}_{sc}=48 becomes an output of the maximum bandwidth acquirer 1508. In this embodiment, the widest allocation bandwidth is M^{RS}_{sc}. However, M^{RS}_{sc} may be selected based on any reference as long as the value is previously defined in transmission and reception. For example, the narrowest allocation bandwidth may be M^{RS}_{sc}, or an average of bandwidths of all transmit antennas may be M^{RS}_{sc}.

TABLE 3

| | Layer number | Allocation |
|---|---|---|
| 0th transmit | 0th layer | 60 to 83 |
| antenna | | |
| 1st transmit | 1st layer | 36 to 71 |
| antenna | | |
| 2nd transmit | 0th layer | 24 to 47 |
| antenna | | |
| 3rd transmit | 2nd layer | 48 to 95 |
| antenna | | |

The maximum prime number calculator 1509 calculates a maximum prime number N^{RS}_{ZC} that does not exceed M^{RS}_{sc} from the input bandwidth M^{RS}_{sc}, and inputs the calculated value to the ZC sequence generator 1501 and the modulus operator 1510. Since the widest bandwidth is M^{RS}_{sc}=48 in the example of Table 3, N^{RS}_{ZC}=47 is obtained.

In this embodiment, the maximum prime number N^{RS}_{ZC} that does not exceed M^{RS}_{sc} is calculated; however, the minimum prime number N^{RS}_{ZC} that exceeds the M^{RS}_{sc} may be calculated.

The ZC sequence generator 1501 generates a ZC sequence x_{q}(m) (0≦m≦N^{RS}_{ZC}−1) with a length N^{RS}_{ZC} by the ZC sequence index q output from the control information receiver 1412 (FIG. 14), the N^{RS}_{ZC} input from the maximum prime number calculator 1509, and Expression (2), and inputs the generated value to the copier 1502.

The copier 1502 copies the output of the ZC sequence generator 1501 by rank R, and inputs the value to the precoder 1503.

The precoder 1503 performs precoding on the input from the copier 1502. Processing of the precoder 1503 is similar to that of the precoder 1405 in FIG. 14. The output of the precoder 1503 is input to the frequency domain cyclic shifter 1504.

Here, the leading index acquirer 1507 acquires a frequency index k_{TOP,u} at the leading end of frequency allocation for a u-th transmit antenna from the allocation information, and inputs the acquired value to the modulus operator 1510 and the time domain cyclic shifter 1506. For example, in the case of allocation as shown in Table 3, the leading index acquirer 1507 extracts k_{TOP,0}=60, k_{TOP,1}=36, k_{TOP,2}=24, and k_{TOP,3}=48 which are frequency indices at the leading ends of the 0th to 3rd transmit antennas, and input the extracted values to the modulus operator 1510 and the time domain cyclic shifter 1506.

The modulus operator 1510 calculates a cyclic shift amount Δᵤ in the frequency domain of each transmit antenna by the following expression, based on the index k_{TOP,u} input from the leading index acquirer 1507 and N^{RS}_{ZC} input from the maximum prime number calculator 1509.

[Math. 24]

Δᵤ=k_{TOP,u} mod N_{ZC}^{RS} Expression (24)

For example, if the frequency allocations for the respective antennas are as shown in Table 3, since N^{RS}_{ZC}=47, Δ₀=13, Δ₁=36, Δ₂=24, and Δ₃=1 are calculated based on Expression (24). A cyclic shift amount Δᵤ for each transmit antenna calculated by the modulus operator 1510 is input to the frequency domain cyclic shifter 1504. The value of the cyclic shift amount Δᵤ may be any absolute value as long as relative values among the transmit antennas are maintained.

The frequency domain cyclic shifter 1504 calculates a sequence x_{q,u}(m) for each transmit antenna by using x_{q}(m) input from the precoder 1503 and Aᵤ input from the modulus operator 1510, based on the following expression.

[Math. 25]

x_{q,u}(m)=x_{q}((m+Δᵤ)mod N_{ZC}^{RS}), 0≦m≦N_{ZC}^{RS}−1 Expression (25)

That is, the frequency domain cyclic shifter 1504 performs processing for applying a cyclic shift in the frequency domain to the ZC sequence. For example, in the case of the frequency allocation in Table 3, a sequence vector x_{q,u} for the u-th transmit antenna output from the frequency domain cyclic shifter 1504 is represented by the following expression.

$$\begin{matrix} [ Math . 26 ] & \\ \{ \begin{matrix}{x}_{q , 0} = [ \begin{matrix}{x}_{q} ( 13 ) & {x}_{q} ( 14 ) & … & {x}_{q} ( 46 ) & {x}_{q} ( 0 ) & … & {x}_{q} ( 12 )\end{matrix} ] \\ {x}_{q , 1} = [ \begin{matrix}{x}_{q} ( 36 ) & {x}_{q} ( 37 ) & … & {x}_{q} ( 46 ) & {x}_{q} ( 0 ) & … & {x}_{q} ( 35 )\end{matrix} ] \\ {x}_{q , 2} = [ \begin{matrix}{x}_{q} ( 24 ) & {x}_{q} ( 25 ) & … & {x}_{q} ( 46 ) & {x}_{q} ( 0 ) & … & {x}_{q} ( 23 )\end{matrix} ] \\ {x}_{q , 3} = [ \begin{matrix}{x}_{q} ( 1 ) & {x}_{q} ( 2 ) & … & {x}_{q} ( 46 ) & {x}_{q} ( 0 )\end{matrix} ]\end{matrix} & Expression ( 26 )\end{matrix}$$

The size of each vector is 1×N^{RS}_{ZC} (=47). The sequence for each transmit antenna calculated by the frequency domain cyclic shifter 1504 is input to the sequence length changing unit 1505. The sequence length changing unit 1505 acquires a use bandwidth M^{RS}ᵤ for each transmit antenna from the input allocation information, and changes the sequence length to an allocation bandwidth for each transmit antenna, by using the input x_{q,u}(m) from the frequency domain cyclic shifter 1504 and the following expression.

[Math. 27]

rᵤ(n)=x_{q,u}(n mod N_{ZC}^{RS}), 0≦n≦Mᵤ^{RS}−1 Expression (27)

That is, since the sequence length of the output of the frequency domain cyclic shifter 1504 is N^{RS}_{ZC}, the sequence length changing unit 1505 changes the sequence length so that the sequence length of the u-th transmit antenna becomes the allocation bandwidth M^{RS}ᵤ. For example, in the example of Table 3, by applying Expression (26) to Expression (27), a sequence is obtained like the following expression.

$$\begin{matrix} [ Math . 28 ] & \\ \{ \begin{matrix}{r}_{0} = [ \begin{matrix}{x}_{q} ( 13 ) & {x}_{q} ( 14 ) & … & {x}_{q} ( 36 )\end{matrix} ] \\ {r}_{1} = [ \begin{matrix}{x}_{q} ( 36 ) & {x}_{q} ( 37 ) & … & {x}_{q} ( 46 ) & {x}_{q} ( 0 ) & … & {x}_{q} ( 24 )\end{matrix} ] \\ {r}_{2} = [ \begin{matrix}{x}_{q} ( 24 ) & {x}_{q} ( 25 ) & … & {x}_{q} ( 46 ) & {x}_{q} ( 0 )\end{matrix} ] \\ {r}_{3} = [ \begin{matrix}{x}_{q} ( 1 ) & {x}_{q} ( 2 ) & … & {x}_{q} ( 46 ) & {x}_{q} ( 0 ) & {x}_{q} ( 1 )\end{matrix} ]\end{matrix} & Expression ( 28 )\end{matrix}$$

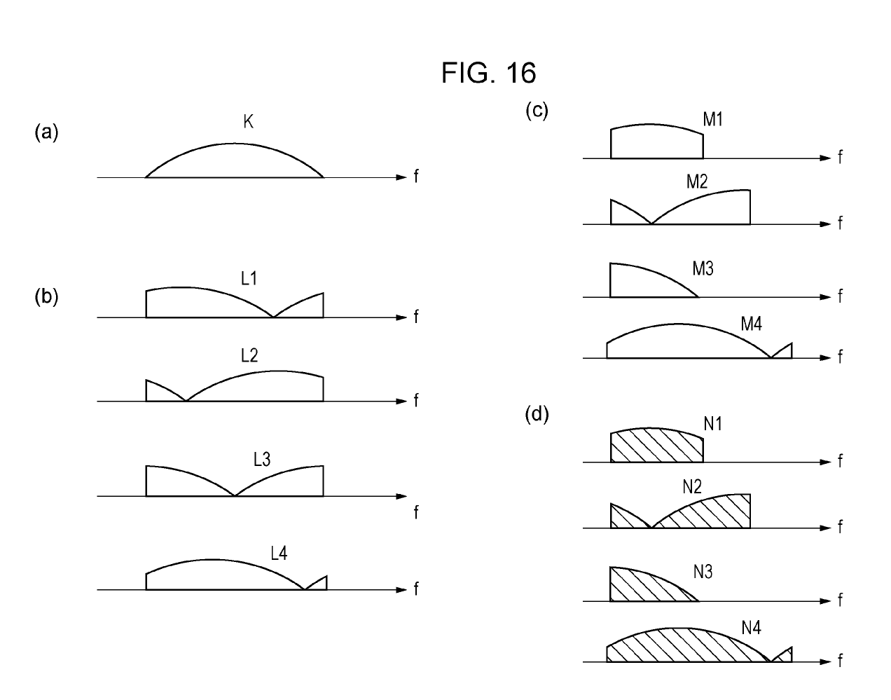

FIGS. 16(a), 16(b), 16(c), and 16(d) are illustrations schematically showing respective outputs of the ZC sequence generator 1501, the frequency domain cyclic shifter 1504, the sequence length changing unit 1505, and the time domain cyclic shifter 1506 in the case of Table 3.

FIG. 16(a) is an illustration schematically showing an output K of the ZC sequence generator 1501. The horizontal axis plots the frequency point. The total number of frequency points in this case is, for example, 47.

FIG. 16(b) is an illustration schematically showing outputs L1, L2, L3, and L4 of the frequency domain cyclic shifter 1504. The outputs L1, L2, L3, and L4 indicate four ZC sequences after the cyclic shift to be allocated to the respective paths of the 0th to 3rd transmit antennas. The cyclic shift amounts in this case are Δ₀=13, Δ₁=36, Δ₂=24, and Δ₃=1 from above in FIG. 16(b) as described above, and the total number of frequency points is 47.

FIG. 16(c) is an illustration schematically showing respective outputs of the sequence length changing unit 1505, and schematically indicates sequences M1 to M4 after the change of the sequence lengths to be allocated to the respective paths of the 0th to 3rd transmit antennas. The sequence M1 has a sequence length of 24, the sequence M2 has a sequence length of 36, the sequence M3 has a sequence length of 24, and the sequence M4 has sequence length of 48.

FIG. 16(d) is an illustration schematically showing respective outputs of the time domain cyclic shifters 1506. Hatching with oblique lines indicates sequences N1 to N4 after the time domain cyclic shift. Also, cyclic shift amounts αᵤ may be respectively 0, π/2, π, and 3π/2 for the paths of the 0th to 3rd transmit antennas. Also, signals from the 0th transmit antenna and the 2nd transmit antenna may be assumed as a composite signal, and may not be separated. In this case, cyclic shift amounts of the 0th to 3rd transmit antennas may be 0, π/2, 0, and 3π/2. The value of αᵤ is not limited thereto.

The output of the time domain cyclic shifter 1506 is input as the output of the DMRS generator 1413 (FIG. 14), to the DMRS multiplexers 1406-0 to 1406-Nₜ−1. In the DMRS multiplexers 1406-0 to 1406-Nₜ−1, the output of the DMRS generator 1413 occupies the 4th and 11th symbols among the 14 symbols in the single subframe, for each of the paths of the transmit antennas 1410-0 to 1410-Nₜ−1 (FIG. 3).

The outputs of the DMRS multiplexers 1406-0 to 1406-Nₜ−1 are input to the mapping units 1407-0 to 1407-Nₜ−1.

The mapping units 1407-0 to 1407-Nₜ−1 provide allocation for frequency arrangements with good channel characteristics for the respective transmit antennas, in response to an instruction from the base station 102b.

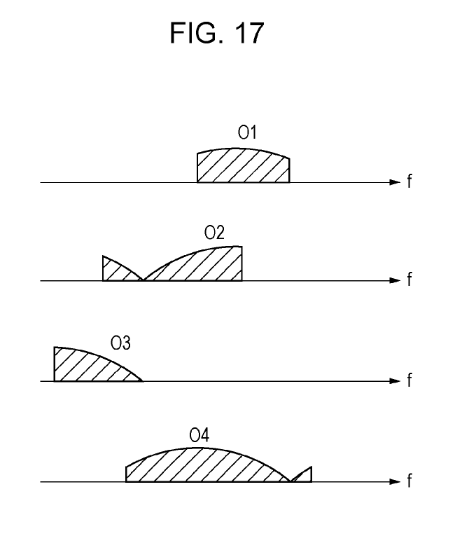

FIG. 17 is an illustration schematically showing outputs O1 to O4 of the mapping units 1407-0 to 1407-3 when the number of transmit antennas is four, and the frequency points are allocated in accordance with Table 3. The outputs O1 to O4 have spectra that seem to be mutually the same at overlap portions on a frequency point. The total numbers of frequency points respectively occupied by the outputs are 24, 36, 24, and 48.

The outputs of the mapping units 1407-0 to 1407-Nₜ−1 are input to the OFDM signal generators 1408-0 to 1408-Nₜ−1.

When a transmission request of a sounding reference signal SRS is notified through the control information from the base station 102b, the OFDM signal generators 1408-0 to 1408-Nₜ₋₁ multiplex SRS on the outputs of the mapping units 1407-0 to 1407-Nₜ−1. This multiplexing is performed by inserting the SRS to the 14th symbol #14 in the single subframe in FIG. 3 as described above. However, the insertion of the SRS is not limited to this method. The SRS generator 1414 creates the SRS under control with a signal from the control information receiver 1412, and supplies the SRS together with allocation information to the OFDM signal generators 1408-0 to 1408-Nₜ−1.

Then, the OFDM signal generators 1408-0 to 1408-Nₜ−1 apply the N_{FFT}-point inverse fast Fourier transform (IFFT), to perform conversion on the input signals from the mapping units 1407-0 to 1407-Nₜ−1 (if the multiplexing of the SRS is performed, the multiplexed signals) from frequency domain signals to time domain signals.

Then, as shown in the lower row in FIG. 3, a CP (cyclic prefix) is inserted into each of the SC-FDMA symbols. The CP employs a copy of a portion for a certain time cut from the backend of the SC-FDMA symbol, and the copy is inserted to the frontend of the SC-FDMA symbol. The SC-FDMA symbols after the CPs are inserted are input to the transmitters 1409-0 to 1409-Nₜ−1. The transmitters 1409-0 to 1409-Nₜ−1 perform D/A (digital-analog) conversion, analog filtering, upconversion to a carrier frequency, etc., on the input SC-FDMA symbols, and then transmits carrier signals from the transmit antennas 1410-0 to 1410-Nₜ−1.

A configuration of the base station device 102b according to the third embodiment is similar to the configuration of the base station device according to the first embodiment (FIG. 7), and the latter configuration may be used with appropriate modification in design. A configuration of a MIMO separator used in the base station device according to the third embodiment is also similar to the configuration of the MIMO separator in the base station device according to the first embodiment (FIG. 8), and the latter configuration may be used with appropriate modification in design.

Supplementary explanation is given for this design change. The channel estimator (709 in FIG. 7) estimates a channel including precoding if precoding is performed. Further, the scheduler (711 in FIG. 7) determines precoding performed in the terminal 101b, and the control information transmitter (712 in FIG. 7) transmits information indicative of the precoding as control information to the terminal 101b. The demapping unit (803 in FIG. 8) in the MIMO separator (704 in FIG. 7) extracts a subcarrier (frequency point or orthogonal frequency) used for transmission of a stream in a path of each transmit antenna, then if a stream in which the same spectrum is received by a plurality of subcarriers is present, known processing is performed for composing the subcarriers, and then outputs the processed result to the IDFT units (705-0 to 705-Nₜ−1 in FIG. 7) for each stream.

As described above, even if the rank R is smaller than the number Nₜ of transmit antennas, by using the same spectrum for each frequency as DMRS for each transmit antenna and applying a different cyclic shift to each transmit antenna, the channel estimator can estimate the channel gain with high accuracy with respect to each transmit antenna without an increase in scale or an increase in power consumption of the device because of the use of complicated calculation. Since an error rate performance of data is improved, throughput can be increased.

### Fourth Embodiment

According to the first to third embodiments, the case of the SU-MIMO is described. In this embodiment, a case of the MU-MIMO is described. For easier understanding, a case is described in which two terminals 101c1 and 101c2 transmit control signals including data signals and reference signals to a single base station 102c by using uplink. Also, a case is described in which the two terminals 101c1 and 101c2 each have a single transmit antenna, and the single base station has two receive antennas. However, this embodiment is not limited to this particular case.

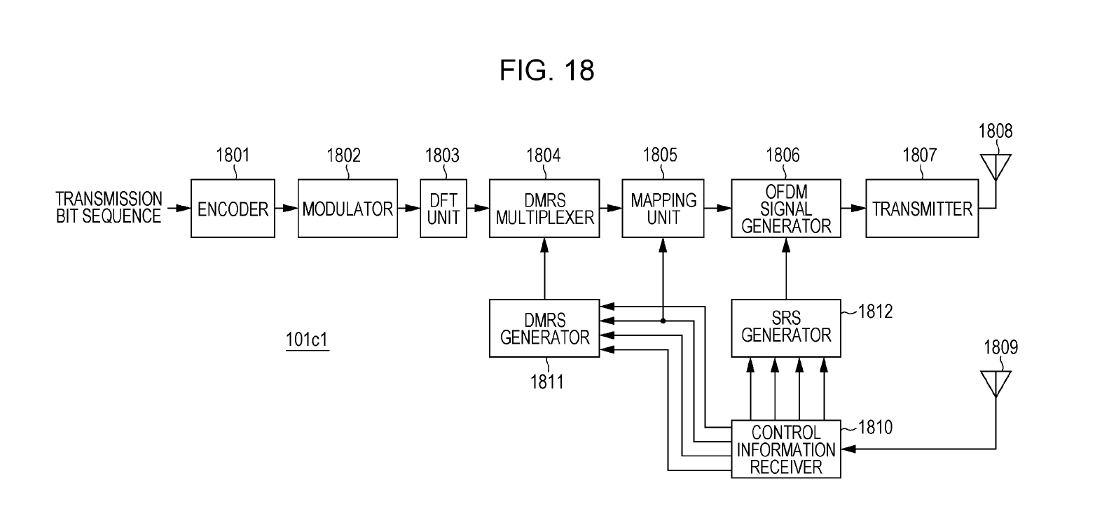

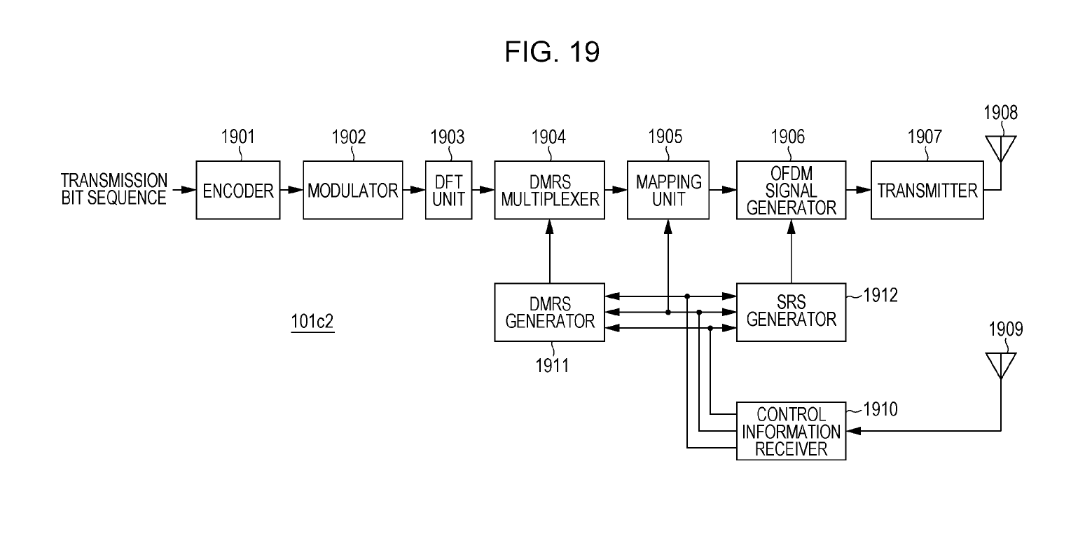

FIGS. 18 and 19 are brief block diagrams showing configurations of the two terminals 101c1 and 101c2 according to the fourth embodiment.

The terminal 101c1 in FIG. 18 includes an encoder 1801, a modulator 1802, a DFT unit 1803, a DMRS multiplexer 1804, a mapping unit 1805, an OFDM signal generator 1806, a transmitter 1807, a transmit antenna 1808, a receive antenna 1809, a control information receiver 1810, a DMRS generator 1811, and a SRS generator 1812.

The terminal 101c2 in FIG. 19 includes an encoder 1901, a modulator 1902, a DFT unit 1903, a DMRS multiplexer 1904, a mapping unit 1905, an OFDM signal generator 1906, a transmitter 1907, a transmit antenna 1908, a receive antenna 1909, a control signal receiver 1910, a DMRS generator 1911, and a SRS generator 1912.

The two terminals 101c1 and 101c2 have similar configurations except for a different point described later. The configuration of the terminal 101c1 is described as a representative of the configurations of the two terminals 101c1 and 101c2.

The encoder 1801 applies error correction encoding to a transmission bit sequence of data, such as audio data, character data, or image data. The output of the encoder 1801 is input to the modulator 1802. Each modulator converts an input bit sequence into a modulation signal on a symbol basis such as QPSK or 16QAM, and outputs the modulation signal. The DFT unit 1803 that performs the N_{DFT}-point discrete Fourier transform applies the discrete Fourier transform to the output of the modulator 1802. Hence a time domain signal is converted into a frequency domain signal.

The output of the DFT unit 1803 is input to the DMRS multiplexer 1804.

The DMRS multiplexer 1804 multiplexes a data signal output from the DFT unit 1803 on a demodulation reference signal DMRS input from the DMRS generator 1811, and forms a transmission frame. The DMRS generator 1811 is described later.

The output of the DMRS multiplexer 1804 is input to the mapping unit 1805.

The mapping unit 1805 performs mapping for each of the SC-FDMA symbols, based on allocation information input from the control information receiver 1810, to a frequency point selected from N_{FFT} points based on the allocation information. N_{DFT} is an integral multiple of the number of subcarriers forming the RB, and N_{DFT}<N_{FFT}.

Here, the control information receiver 1810 is described. The control information receiver 1810 receives control information from the base station 102c through the receive antenna 1809. The control information receiver 1810 inputs allocation information in the control information to the mapping unit 1805. Also, the control information receiver 1810 calculates a sequence number q, a cyclic shift α, and a common sequence length of a ZC sequence from the control information, and inputs the calculated values to the DMRS generator 1811.

The output of the mapping unit 1805 is input to the OFDM signal generator 1806.

When a transmission request of a sounding reference signal SRS is notified through the control information from the base station 102c, the OFDM signal generator 1806 further multiplexes the SRS on the output of the mapping unit 1805. For example, this multiplexing is performed by inserting the SRS to the 14th symbol #14 in the single subframe in FIG. 3. However, the insertion of the SRS is not limited to this method.

Then, the OFDM signal generator 1806 applies the N_{FFT}-point inverse fast Fourier transform, to perform conversion on the input signal from the mapping unit 1805 (if the multiplexing of the SRS is performed, the multiplexed signal) from a frequency domain signal to a time domain signal.

Then, as shown in the lower row in FIG. 3, a CP (cyclic prefix) is inserted into each of the SC-FDMA symbols. The CP employs a copy of a portion for a certain time cut from the backend of the SC-FDMA symbol, and the copy is inserted to the frontend of the SC-FDMA symbol. The SC-FDMA symbol after the CP is inserted is input to the transmitter 1807. The transmitter 1807 performs D/A (digital-analog) conversion, analog filtering, upconversion to a carrier frequency, etc., on the input SC-FDMA symbol, and then transmits a carrier signal from the transmit antenna 1808.

Here, the DMRS generator 1811 is described in detail.

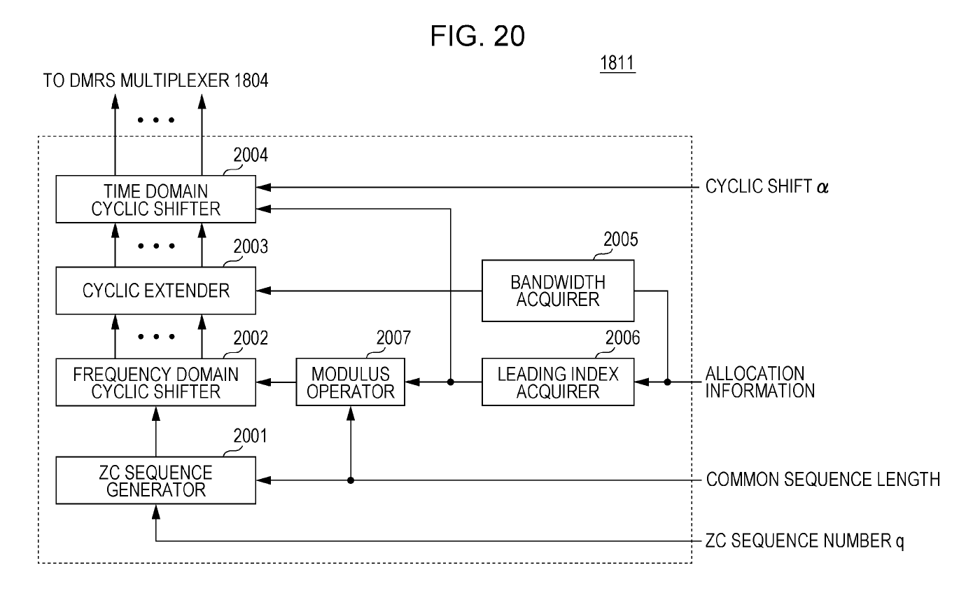

FIG. 20 shows an example of a configuration of the DMRS generator 1811.

The DMRS generator 1811 includes a ZC sequence generator 2001, a frequency domain cyclic shifter 2002, a cyclic extender 2003, a time domain cyclic shifter 2004, a bandwidth acquirer 2005, a leading index acquirer 2006, and a modulus operator 2007.

First, the common sequence length N^{RS}_{ZC} input from the control information receiver 1810 (FIG. 18) is input to the ZC sequence generator 2001 and the modulus operator 2007.

The common sequence length N^{RS}_{ZC} is common to the terminal 101c1 and the terminal 101c2. Also, the common sequence length N^{RS}_{ZC} may be the maximum prime number that does not exceed the bandwidth if the transmit antenna of the terminal 101c1 and the transmit antenna of the terminal 101c2 have the same frequency bandwidth. In contrast, if the frequency bandwidth is not the same, the common sequence length N^{RS}_{ZC} may be calculated from the maximum or minimum bandwidth, or an average bandwidth. Further, the common sequence length may be determined with regard to PH (power headroom) or a modulation scheme of each terminal.

The ZC sequence generator 2011 generates a ZC sequence x_{q}(m) (0≦m≦N^{RS}_{ZC}−1) with a length N^{RS}_{ZC} by the input common sequence length N^{RS}_{ZC}, the ZC sequence index q input from the control information receiver 1810, and Expression (2), and inputs the generated value to the frequency domain cyclic shifter 2002. A ZC sequence index q of the terminal 101c1 and a ZC sequence index q of the terminal 101c2 may be the same or different.

Meanwhile, allocation information input from the control information receiver 1810 is input to the bandwidth acquirer 2005 and the leading index acquirer 2006. The bandwidth acquirer 2005 acquires allocation bandwidth M^{RS}_{sc} of each transmit antenna from the input allocation information, and inputs this information to the cyclic extender 2003. Allocation information of the terminal 101c1 and allocation information of the terminal 101c2 may be the same or different.

Also, the leading index acquirer 2006 acquires a frequency index k_{TOP,u} at the leading end of frequency allocation for a u-th transmit antenna from the allocation information input from the control information receiver 1810, and inputs the acquired value to the modulus operator 2007. The modulus operator 2007 calculates a cyclic shift amount Δᵤ of each transmit antenna by Expression (5) described above, based on the index k_{TOP,u} at the leading end at each transmit antenna input from the leading index acquirer and the common sequence length N^{RS}_{ZC}, and inputs the calculated value to the frequency domain cyclic shifter 2002.

The frequency domain cyclic shifter 2002 calculates a sequence x_{q,u}(m) for each transmit antenna by using x_{q}(m) input from the ZC sequence generator 2001 and the cyclic shift amount Δᵤ input from the modulus operator 2007, based on Expression (6). That is, the frequency domain cyclic shifter 2002 performs processing for applying a cyclic shift to the ZC sequence. The cyclic shift of the frequency domain cyclic shifter 2002 is a cyclic shift in the frequency domain, and is different from a cyclic shift in the time domain.

The sequence x_{q,u}(m) for each transmit antenna calculated by the frequency domain cyclic shifter 2002 is input to the cyclic extender 2003. The cyclic extender 2003 calculates rᵤ(n) by using the sequence x_{q,u}(m) with a length N^{RS}_{ZC} input from the frequency domain cyclic shifter 2002, the bandwidth M^{RS}_{SC} input from the bandwidth acquirer, and Expression (8). That is, the output of the frequency domain cyclic shifter of the sequence length N^{RS}_{ZC} is extended by the cyclic extender to the sequence length M^{RS}_{sc}.

The obtained output of the cyclic extender 2003 is input to the time domain cyclic shifter 2004. The time domain cyclic shifter 2004 provides time domain cyclic shift for the input rᵤ(n) by using a cyclic shift α based on Expression (10). A cyclic shift α of the terminal 101c1 and a cyclic shift α of the terminal 101c2 may be the same or different.

The output of the time domain cyclic shifter 2004 is input as the output of the DMRS generator 1811, to the DMRS multiplexers 1804 (FIG. 18).

A configuration of the base station device 102c according to the fourth embodiment is similar to the configuration of the base station device according to the first embodiment (FIG. 7), and the latter configuration may be used with appropriate modification in design. A configuration of a MIMO separator used in the base station device 102c according to the fourth embodiment is also similar to the configuration of the MIMO separator 704 according to the first embodiment (FIG. 8), and the latter configuration may be used with appropriate modification in design.

Supplementary explanation is given for this design change. The control information transmitter determines the common sequence length from frequency allocation information for each transmit antenna of each terminal input from the scheduler, and transmits the sequence length to the terminal 101c1 and the terminal 101c2 through the transmit antenna.

The number of terminals according to this embodiment is not limited to two, and may be any number. Also, the number of transmit antennas of each terminal is not limited to one, and may be plural.

As described above, in the case of MU-MIMO, even when a plurality of terminals have different allocation frequencies, by applying a different cyclic shift for each transmit antenna by using the same spectrum with each frequency as the demodulation reference signal DMRS for each transmit antenna, the channel estimator can estimate the channel gain with respect to each transmit antenna with high accuracy without an increase in scale or an increase in power consumption of the device because of the use of complicated calculation. Since an error rate performance of data is improved, throughput can be increased.

### Fifth Embodiment

In the first to fourth embodiments, the case is described in which an aspect (form) of the present invention is applied particularly to the demodulation reference signal DMRS. In this embodiment, a case is described in which the aspect (form) of the present invention is applied to a sounding reference signal SRS for scheduling.

In this embodiment, for easier understanding, a case is described in which two terminals 101d1 and 101d2 transmit control signals including data signals and reference signals to a single base station 101d by using uplink. Also, a case is described in which the terminal 101d1 includes a single transmit antenna, the terminal 101d2 includes two transmit antennas, and the single base station includes a plurality of receive antennas. However, this embodiment is not limited to this particular case.

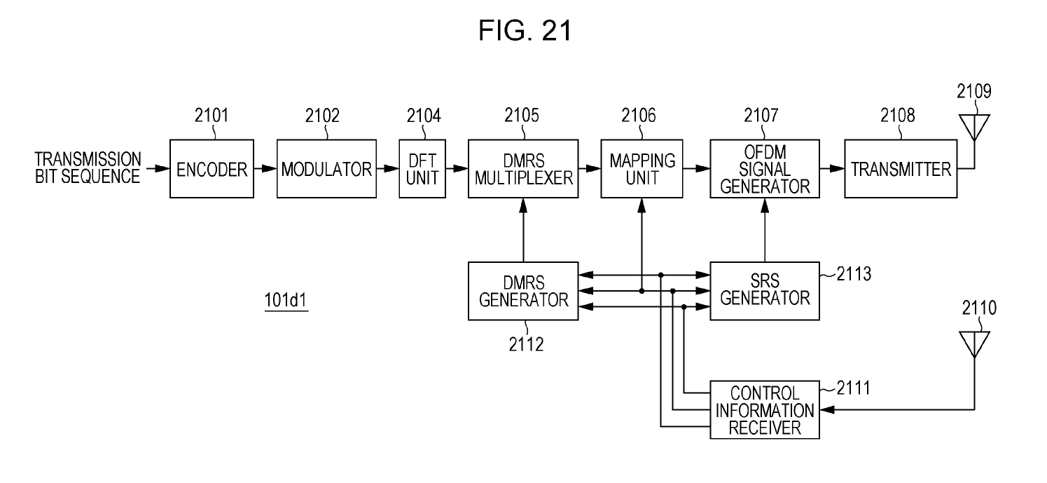

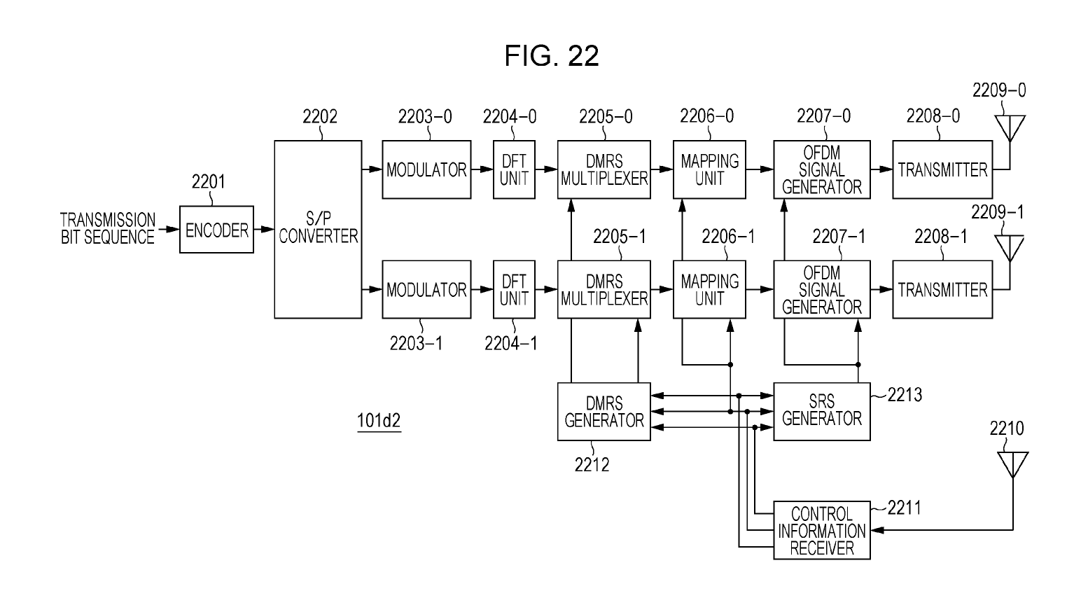

FIGS. 21 and 22 are brief block diagrams showing configurations of the two terminals 101d1 and 101d2 according to the fifth embodiment.

The terminal 101d1 in FIG. 21 includes an encoder 2101, a modulator 2102, a DFT unit 2104, a DMRS multiplexer 2105, a mapping unit 2106, an OFDM signal generator 2107, a transmitter 2108, a transmit antenna 2109, a receive antenna 2110, a control signal receiver 2111, a DMRS generator 2112, and a SRS generator 2113.

The terminal 101d2 shown in FIG. 22 includes an encoder 2201, a S/P converter 2202, modulators 2203-0 and 2203-1, DFT units 2204-0 and 2204-1, DMRS multiplexers 2205-0 and 2205-1, mapping units 2206-0 and 2206-1, OFDM signal generators 2207-0 and 2207-1, transmitters 2208-0 and 2208-1, transmit antennas 2209-0 and 2209-1, a receive antenna 2210, a control information receiver 2211, a DMRS generator 2212, and a SRS generator 2213.

First, a configuration of the terminal 101d2 including the two transmit antennas is described with reference to FIG. 22.

The encoder 2201 applies error correction encoding to a transmission bit sequence of data, such as audio data, character data, or image data. The output of the encoder 2201 is input to the S/P (serial to parallel) converter 2202. The S/P converter 2202 performs serial-parallel conversion on the input transmission bit sequence to correspond to the number of simultaneous transmit antennas. The output of the S/P converter 2202 is input to the modulators 2203-0 and 2203-1. Each modulator converts an input bit sequence into a modulation signal on a symbol basis such as QPSK or 16QAM, and outputs the modulation signal. The DFT units 2204-0 and 2204-1 that perform the N_{DFT}-point discrete Fourier transform apply the discrete Fourier transform to the outputs of the modulators 2203-0 and 2203-1. Hence, time domain signals are converted into frequency domain signals.

The outputs of the DFT units 2204-0 and 2204-1 are input to the DMRS multiplexers 2205-0 and 2205-1.

The DMRS multiplexers 2205-0 and 2205-1 multiplex data signals output from the DFT units 2204-0 and 2204-1 on a demodulation reference signal DMRS input from the DMRS generator 2212, and form transmission frames.

An example of a configuration of a transmission frame is the same as that in FIG. 3, and this is incorporated herein.

A single frame shown in the upper row in FIG. 3 is formed of 10 subframes on the time axis. A single subframe shown in the middle row in FIG. 3 is formed of 14 symbols in total including 12 data SC-FDMA symbols and 2 DMRS symbols. Here, the DMRS symbol is inserted to a 4th symbol (#4) and an 11th symbol (#11) among the 14 symbols as shown in the middle row in FIG. 3.

Also, regarding a 14th (#14) SC-FDMA symbol in each subframe, a data SC-FDMA symbol or a SRS (sounding reference signal) symbol may be transmitted. The symbol to be transmitted is notified from the base station 102d to the terminals 101d1 and 101d2.

The outputs of the DMRS multiplexers 2205-0 and 2205-1 are input to the mapping units 2206-0 and 2206-1.

The mapping units 2206-0 and 2206-1 provide allocation for frequency arrangements with good channel characteristics for the respective transmit antennas, in response to an instruction from the base station 102d.

This frequency allocation may be performed by selecting a frequency point from the three cases of the same, separate, and partly overlapped frequency points, with regard to the correlation among the plurality of transmit antennas of the terminal. Alternatively, only the same frequency point may be selected if it is permitted that allocation of good frequency arrangement is sacrificed by a certain degree.

The outputs of the mapping units 2206-0 and 2206-1 are input to the OFDM signal generators 2207-0 and 2207-1.

Here, the OFDM signal generators 2227-0 and 2227-1 are described in detail.

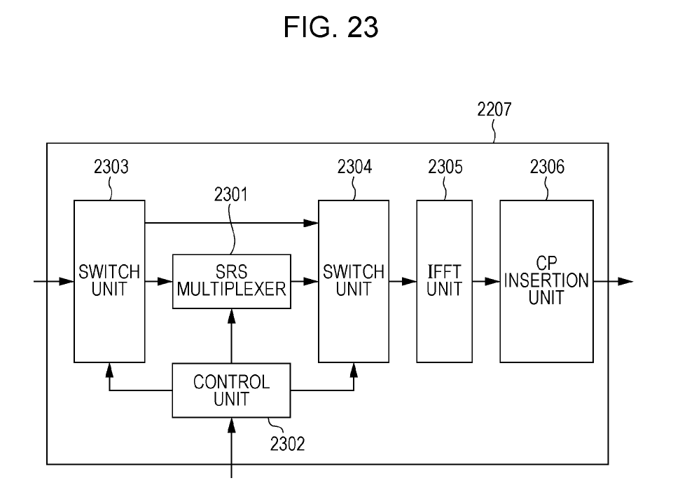

The two OFDM signal generators 2227-0 and 2207-1 (and the OFDM signal generator 2107 of the terminal 101d1) have the same configuration, and hence reference sign “2207” is collectively applied to these generators. An example of this configuration is shown in FIG. 23. The method of applying the reference sign is also applied to the mapping units.

The OFDM signal generator 2207 shown in FIG. 23 includes a SRS multiplexer 2301, a control unit 2302, switch units 2303 and 2304, an IFFT unit 2305, and a CP insertion unit 2306.

The output from the mapping unit 2206 is input to the switch unit 2306. The switch unit 2303 inputs the output from the mapping unit 2206 to the SRS multiplexer 2301 when a SRS is multiplexed under control by the control unit 2302, and inputs the output from the mapping unit 2206 directly to the switch unit 2304 when a SRS is not multiplexed.

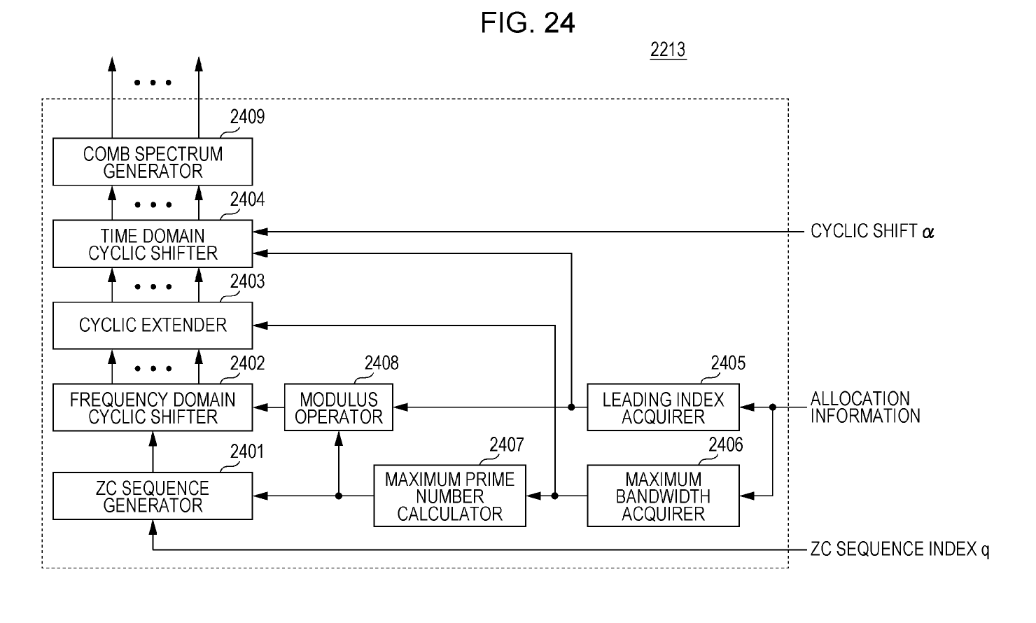

FIG. 24 is a brief block diagram showing an example of a configuration of the SRS generator 2213 of the terminal 101d2. A configuration of the SRS generator 2113 of the terminal 101d1 is similar to that shown in FIG. 24.

The SRS generator 2213 includes a ZC sequence generator 2401, a frequency domain cyclic shifter 2402, a cyclic extender 2403, a time domain cyclic shifter 2404, a leading index acquirer 2405, a maximum bandwidth acquirer 2406, a maximum prime number calculator 2407, a modulus operator 2408, and a comb spectrum generator 2409.

Similarly to the DMRS, the SRS is generated by using a ZC sequence (Zadoff-Chu sequence) for example. Hence, the SRS generator has a basic configuration similar to that of the DMRS generator.

First, allocation information input from the control information receiver 2211 (FIG. 22) is input to the leading index acquirer 2405 and the bandwidth acquirer 2406. The maximum bandwidth acquirer 2406 acquires an allocation bandwidth M^{RS}_{SC} in a path of each of the transmit antennas 2209-0 and 2209-1 from the input allocation information, and inputs the acquired value to the maximum prime number calculator 2407 and the cyclic extender 2403.

The maximum prime number calculator 2407 calculates a maximum prime number N^{RS}_{ZC} that does not exceed M^{RS}_{sc}, from a plurality of input bandwidths M^{RS}_{sc}.

The output N^{RS}_{ZC} of the maximum prime number calculator 2407 is input to the ZC sequence generator 2401 and the modulus operator 2408. The ZC sequence generator 2401 generates a ZC sequence x_{q}(m) (0≦m≦N^{RS}_{ZC}−1) with a length N^{RS}_{ZC} by the input N^{RS}_{ZC}, the ZC sequence index q input from the control information receiver 2211 (FIG. 22), and Expression (2) described above, and inputs the generated value to the frequency domain cyclic shifter 2402. The ZC sequence index q may be the same value as the value that is input to the DMRS generator 2212 (FIG. 22).

Also, the leading index acquirer 2405 acquires a frequency index k_{TOP,u} at the leading end of frequency allocation to a u-th transmit antenna from the allocation information input from the control signal receiver 2211 (FIG. 22), and inputs the acquired value to the modulus operator 2408. Frequency allocation widths of SRSs transmitted from the transmit antennas 2209-0 and 2209-1 may be the same or different.

The modulus operator 2408 calculates a cyclic shift amount Δᵤ of each of the transmit antennas 2209-0 and 2209-1 by Expression (5) described above, based on the index k_{TOP,u} at the leading end at each of the transmit antennas 2209-0 and 2209-1 input from the leading index acquirer 2405 and the prime number N^{RS}_{ZC} input from the maximum prime number calculator 2407.

A cyclic shift amount Δᵤ for each of the transmit antennas 2209-0 and 2209-1 calculated by the modulus operator 2408 is input to the frequency domain cyclic shifter 2402.

The frequency domain cyclic shifter 2402 calculates a sequence x_{q,u}(m) for each of the transmit antennas 2209-0 and 2209-1 by using x_{q}(m) input from the ZC sequence generator 2401 and Δᵤ input from the modulus operator 2408, based on Expression (6) described above.

The cyclic extender 2403 extends the input sequence to a sequence length M^{RS}_{sc}, and outputs the sequence. That is, the frequency domain cyclic shifter 2402 performs processing for applying a cyclic extension to the ZC sequence. The obtained output of the cyclic extender 2403 is input to the time domain cyclic shifter 2404.

The time domain cyclic shifter 2404 provides time domain cyclic shift for the input rᵤ(n) based on Expression (10) described above. The value of the cyclic shift a (equivalent to cyclic shift or linear phase offset) to be input is different from the value to be input to the DMRS generator 2212.

The spectrum of each transmit antenna output from the time domain cyclic shifter 2404 is input to the comb spectrum generator 2409.

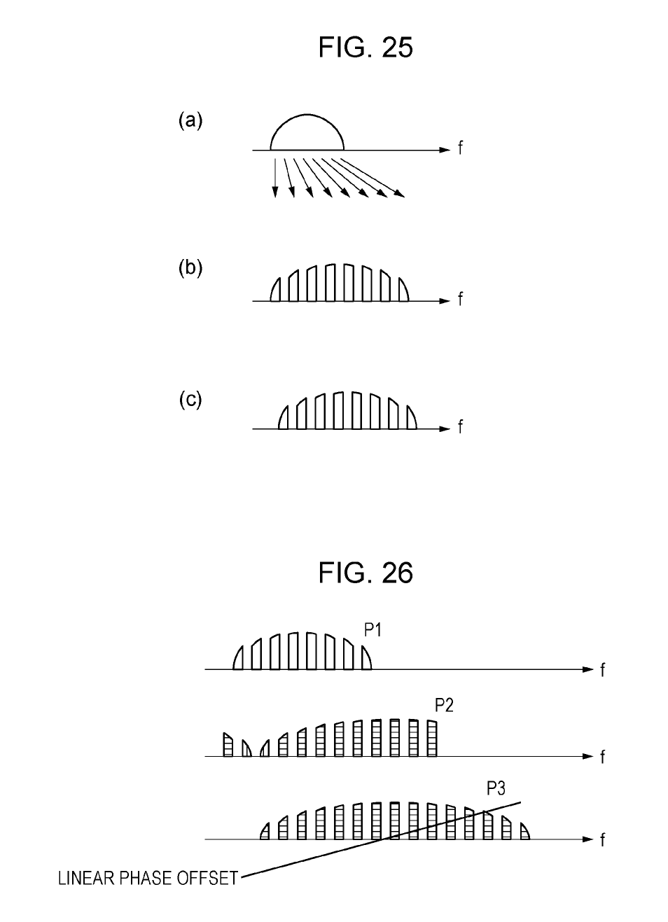

As shown in FIGS. 25(a), 25(b), and 25(c), the comb spectrum generator 2409 insert zero between spectra for each input spectrum, generates a spectrum with a doubled sequent length, and outputs the spectrum.

This point is described in more detail. FIG. 25(a) is an illustration schematically showing an input spectrum in an arcuate curve that is input from the time domain cyclic shifter 2404 to the comb spectrum generator 2409. The horizontal axis plots the frequency point f. FIGS. 25(b) and 25(c) indicate outputs from the comb spectrum generator 2409. Eight arrows in FIG. 25(a) indicate that, for example, eight spectra are dispersed on a frequency point f, and output from the comb spectrum generator 2409.

Hence, FIGS. 25(b) and 25(c) show two patterns formed depending on whether odd-number frequency points are zero or even-number spectra are zero. The frequency patterns of both are mutually orthogonal to each other. One of these is input from the SRS generator 2213 to the OFDM signal generator 2107 of the terminal 101d1 and the other is input to the OFDM signal generator 2207 of the terminal 101d2.

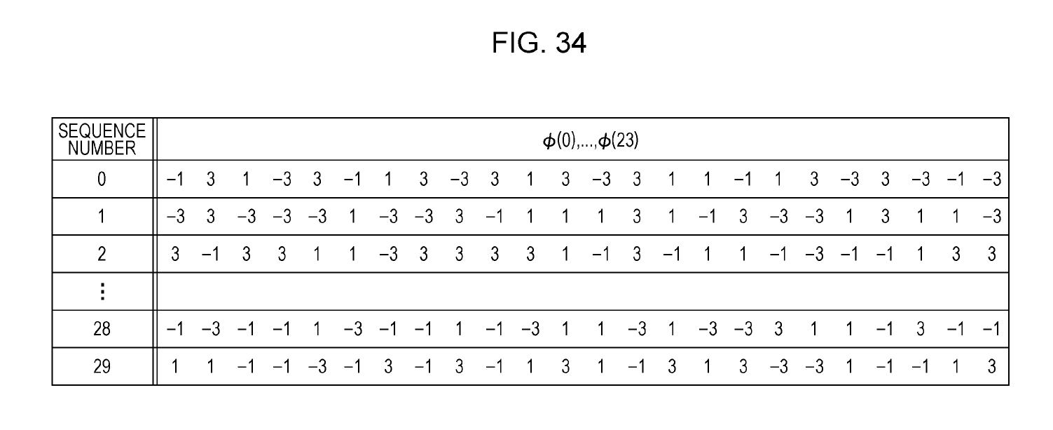

For example, if the minimum bandwidth of a SRS is 4 RBs (that is, 48 subcarriers), the input to the comb spectrum generator 2409 is 2 RBs (that is, 24 subcarriers). A ZC sequence generated by the ZC sequence generator 2401 at this time uses a sequence shown in FIG. 34. Also, if the bandwidth of a SRS is a value other than 4 RBs, a ZC sequence is generated based on Expression (2) described above.

The SRS multiplexer 2301 performs allocation for frequency arrangement of the SRS in accordance with an instruction from the base station 102d.

FIG. 26 is a conceptual diagram explaining the frequency allocation. In FIG. 26, P1 represents an output from the SRS multiplexer of the terminal 101d1, P2 represents an output from the SRS multiplexer in a path of the transmit antenna 2209-0 of the terminal 101d2, and P3 is an output from the SRS multiplexer in a path of the transmit antenna 2209-1 of the terminal 101d2. The horizontal axis plots the frequency point f.

If the output P1 on the frequency point f has 0 at an odd-numbered frequency point, the outputs P2 and P3 each have 0 at an even-numbered frequency point. Thus, the outputs P1 and P2 are orthogonal to each other, and the outputs P1 and P3 are orthogonal to each other. Also, regarding the relationship between the outputs P2 and P3, since P3 is treated with the linear phase offset, the outputs P2 and P3 are also orthogonal to each other. The outputs P2 and P3 have spectra that seem to be mutually the same at overlap portions on a frequency point f.

The above-described linear phase offset applies an offset so that adjacent subcarriers have 90-degree-different phases in the case of two transmit antennas since the adjacent subcarriers are zero. Accordingly, subcarriers with spectra have 180-degree-different phases, and orthogonalization can be provided by using the two subcarriers. If the number of transmit antennas is four, an offset is applied so that adjacent subcarriers have 45-degree-different phases. As a result, by using the four subcarriers, orthogonalization of respective SRSs can be performed.

The output of the switch unit 2304 of each of the OFDM signal generators 2207-0 and 2207-1 is input to the IFFT unit 2305. The IFFT unit 2305 applies the N_{FFT}-point inverse fast Fourier transform IFFT, so that a frequency domain signal is converted into a time domain signal, and a cyclic prefix (CP) corresponding to a guard time in the CP insertion unit 2306 is inserted into a SC-FDMA symbol after the conversion. SC-FDMA symbols after CPs are inserted are input to the transmitters 2208-0 and 2208-1 (FIG. 22).

The transmitters 2208-0 and 2208-1 perform D/A (digital-analog) conversion, orthogonal modulation, analog filtering, upconversion to a carrier frequency from a baseband, etc., on the symbols. Then, radio frequency signals that carry the SC-FDMA symbols after the insertion of the CPs are transmitted from the transmit antennas 2209-0 and 209-1 to the base station 102d.

As described above, the signals transmitted from the terminal 101d2 propagate through the radio channels and are received by a number Nᵣ of receive antennas of the base station 102d.

The configuration of the terminal 101d1 including the single transmit antenna was already described. Operation of the configuration is similar to that of the terminal 101d2 except that the transmit antenna 2109 includes not two paths but a single path. Also, the terminal 101d1 may include a plurality of transmit antennas, and mutually orthogonal sounding reference signals SRS may be transmitted from the plurality of antennas of both the terminal 101d1 and the terminal 101d2.

A configuration of the base station device 102d according to the fifth embodiment is similar to the configuration of the base station device according to the first embodiment (FIG. 7), and the latter configuration may be used with appropriate modification in design. A configuration of a MIMO separator used in the base station device 102d according to the fifth embodiment is also similar to the configuration of the MIMO separator 704 according to the first embodiment (FIG. 8), and the latter configuration may be used with appropriate modification in design.

As described above, in this embodiment, when the sounding reference signals SRS are simultaneously transmitted from the one or the plurality of transmit antennas included in each of the plurality of terminals, by applying the cyclic shift in the frequency domain, the SRSs can be transmitted from the respective transmit antennas without interference. As a result, the base station can flexibly select the frequency band with which the terminal transmits the SRS, and hence the channel states of the respective terminals can be efficiently recognized.

### Sixth Embodiment

In the first to fifth embodiments, the case is described in which transmission is performed directly from the terminal to the base station.

In a sixth embodiment, a relay station is arranged between a terminal and a base station, and transmission is performed indirectly from the terminal to the base station.

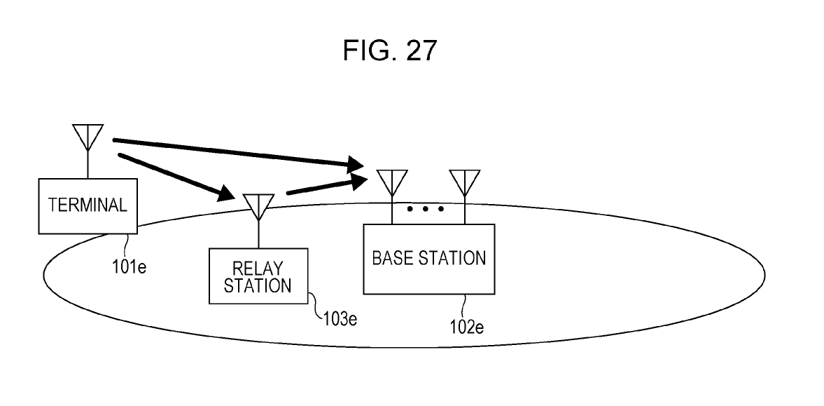

FIG. 27 is a brief block diagram showing a configuration of a radio communication system according to the sixth embodiment.

The radio communication system in FIG. 27 includes a terminal 101e, a base station 102e, and a relay station 103e. The relay station may be occasionally called a relay station device, a repeater station, or a repeater station device.

FIG. 27 shows only a single terminal 101e for easier viewing of the drawing.

The terminal 101e includes a single transmit antenna, and the base station 102e includes a plurality of receive antennas. The relay station 103e includes a transmission and receive antenna. Alternatively, the base station 102e may occasionally include a single receive antenna. Also, the transmit antenna of the terminal 101e may also serve as a receive antenna, or the terminal 101e may include an independent receive antenna. The receive antenna of the base station 102e may also serve as a transmit antenna, or the base station 102e may include an independent transmit antenna. The transmit and receive antenna of the relay station 103e may be also formed of an independent transmit antenna and an independent receive antenna.

This embodiment is not limited to the particular case, and known MIMO technique, such as transmission diversity or spatial multiplexing, may be applied.

The terminal 101e uses the transmit antenna and transmits a radio signal to the base station 102e. This radio signal is received by the plurality of receive antennas of the base station 102e through the relay station 103e. Also, this radio signal is directly received by the plurality of receive antennas of the base station 102e without the relay station 103e.

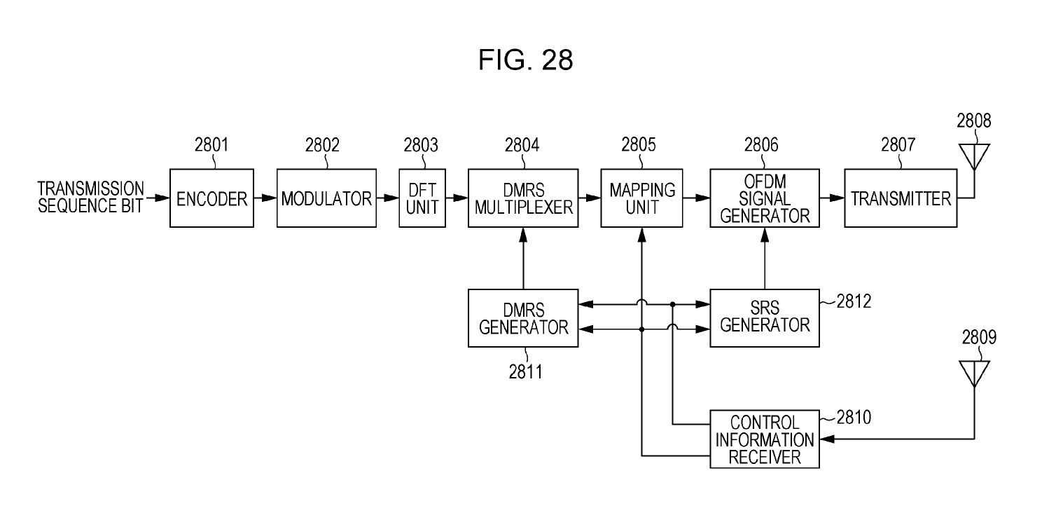

FIG. 28 is a brief block diagram showing a configuration of the terminal 101e.

The terminal 101e includes an encoder 2801, a modulator 2802, a DFT unit 2803, a DMRS multiplexer 2804, a mapping unit 2805, an OFDM signal generator 2806, a transmitter 2807, a transmit antenna 2808, a receive antenna 2809, a control information receiver 2810, a DMRS generator 2811, and a SRS generator 2812.

The encoder 2801 applies error correction encoding to a transmission bit sequence of data, such as audio data, character data, or image data. The output of the encoder 2801 is input to the modulator 2802. The modulator 2802 converts an input bit sequence into a modulation signal on a symbol basis such as QPSK or 16QAM, and outputs the modulation signal. The DFT unit 2803 that performs the N_{DFT}-point discrete Fourier transform applies the discrete Fourier transform to the output of the modulator 2802. Hence a time domain signal is converted into a frequency domain signal.

The output of the DFT unit 2803 is input to the DMRS multiplexer 2804.

The DMRS multiplexer 2804 multiplexes a data signal output from the DFT unit 2803 on a demodulation reference signal DMRS input from the DMRS generator 2811, and forms a transmission frame. The DMRS generator 2811 is described later.

The output of the DMRS multiplexer 2804 is input to the mapping unit 2805.

The mapping unit 2805 performs mapping for each of the SC-FDMA symbols, based on allocation information input from the control information receiver 2810, to correspond to a frequency point selected from N_{FFT} points based on the allocation information. It is to be noted that N_{DFT} is an integral multiple of the number of subcarriers forming the RB, and N_{DFT}<N_{FFT}.

Here, the control information receiver 2810 is described.

The control information receiver 2810 receives control information from the base station 102e through the receive antenna 2809. The control information receiver 2810 inputs the allocation information in the control information to the mapping unit 2805 and the DMRS generator 2811. Also, the control information receiver 2810 calculates a sequence number q and a cyclic shift a of a ZC sequence from the control information, and inputs the calculated values to the DMRS generator 2812.

The output of the mapping unit 2805 is input to the OFDM signal generator 2806.

When a transmission request of a sounding reference signal SRS is notified through the control information from the base station 102e, the OFDM signal generator 2806 further multiplexes a SRS on the output of the mapping unit 2805. This SRS is supplied from the SRS generator 2812. For example, this multiplexing is performed by inserting the SRS to the 14th symbol #14 in the single subframe in FIG. 3. However, the insertion of the SRS is not limited to this method.

Then, the OFDM signal generator 2806 applies the N_{FFT}-point inverse fast Fourier transform, to perform conversion on the input signal from the mapping unit 2805 (if the multiplexing of the SRS is performed, the multiplexed signal) from a frequency domain signal to a time domain signal.

Then, as shown in the lower row in FIG. 3, a CP (cyclic prefix) is inserted into each of the SC-FDMA symbols. The CP employs a copy of a portion for a certain time cut from the backend of the SC-FDMA symbol, and the copy is inserted to the frontend of the SC-FDMA symbol.

The SC-FDMA symbol after the CP is inserted is input to the transmitter 2807. The transmitter 2807 performs D/A (digital-analog) conversion, analog filtering, upconversion to a carrier frequency, etc., on the input SC-FDMA symbol, and then transmits a carrier signal from the transmit antenna 2808.

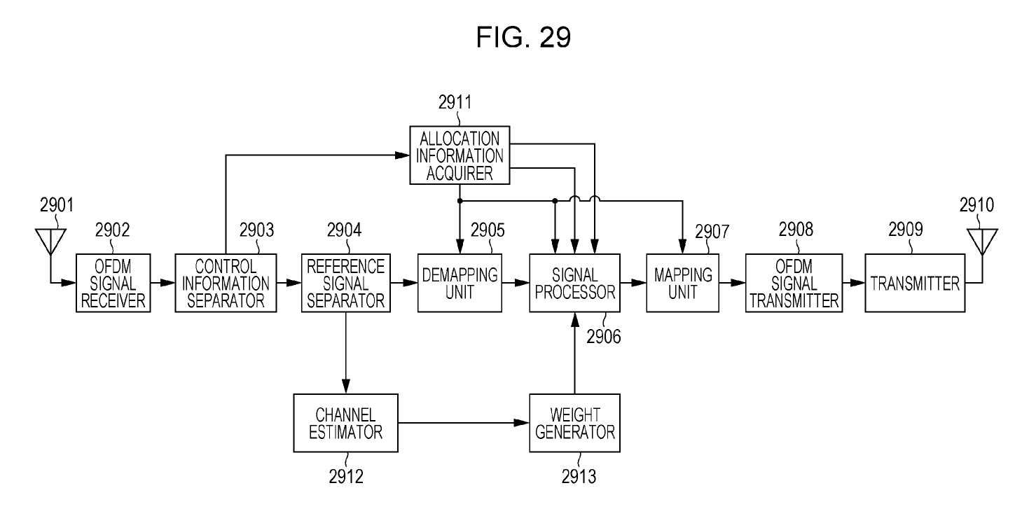

FIG. 29 is a brief block diagram showing a configuration of the relay station 103e.

The relay station 103e, a receive antenna 2901, an OFDM signal receiver 2902, a control information separator 2903, a reference signal separator 2904, a demapping unit 2905, a signal processor 2906, a mapping unit 2907, an OFDM signal transmitter 2908, a transmitter 2909, a transmit antenna 2910, an allocation information acquirer 2911, a channel estimator 2912, and a weight generator 2913 are included.

Described below is a case in which the receive antenna 2901 of the relay station 103e is used to receive signals transmitted from the terminal 101e by single carrier transmission.

Other known configuration included in the relay station 103e is omitted in FIG. 29 for easier understanding of the description, like the other embodiments.

A transmission signal from the terminal 101e and a control information signal notified from the base station 102e received by the receive antenna 2901 of the relay station 103e are input to the OFDM signal receiver 2902. The OFDM signal receiver 2902 performs downconversion from a carrier frequency to a baseband signal, analog filtering, A/D (analog-digital) conversion, and elimination of a cyclic prefix CP for each SC-FDMA symbol, then applies the N_{FFT}-point fast Fourier transform (FFT) for the signal after the elimination of the cyclic prefix CP, and performs conversion from a time domain signal to a frequency domain signal.

The frequency domain signal is then input to the control information separator 2903. The control information separator 2903 separates control information from the base station 102e to the terminal 101e, and control information from the base station 102e to the relay station 103e, from other information (data signals and reference signals). The control information separator 2903 also inputs the separated control information to the allocation information acquirer 2911, and the other information to the reference signal separator 2904.

The allocation information acquirer 2911 receives the control information notified by the base station 102e to the terminal 101e, and the control information notified by the base station 102e to the relay station 103e. Information relating to a frequency that is used by the terminal 101e (allocation information) determined by the base station 102e is acquired from the control information, and is input to the demapping unit 2905 and the signal processor 2906. Further, information relating to a frequency that is used by the relay station 103e for transmission to the base station 102e determined by the base station 102e is input to the mapping unit 2907. Also, a ZC sequence index q used by the terminal 101e for transmission and a cyclic shift amount in the time domain to be used by the relay station 103e are extracted from the control information, and are input to the signal processor 2906.

The reference signal separators 2904 separates the demodulation reference signals DMRSs at the 4th (#4) and 11th (#11) symbols in the single subframe in the middle row in FIG. 3, from a sounding reference signal SRS if the SRS is inserted into the 14th (#14) symbol, and inputs the reference signals to the channel estimator 2912. Also, the reference signal separator 2904 inputs the 1st to 3rd, 5th to 10th, 12th, and 13th data SC-FDMA symbols in the single subframe in the middle row in FIG. 3 and the data SC-FDMA symbol if a data SC-FDMA symbol is inserted into the 14th symbol, to the demapping unit 2905.

The channel estimator 2912 estimates radio channels (phase and amplitude of a channel constant of a radio channel) between the transmit antenna 2808 of the terminal 101e and the receive antenna 2901 of the relay station 103e in a band in which a data signal is transmitted, by using the received demodulation reference signal DMRS. The obtained channel estimation value is input to the weight generator 2913.

The demapping unit 2905 extracts a frequency (subcarrier) used by the terminal 101e for transmission from the entire system band, based on allocation information of a transmission signal of the terminal 101e input from the allocation information acquirer 2911. The extracted signal is input to the signal processor 2906.

The signal processor 2906 performs signal processing on the signal input from the demapping unit 2905, generates a spectrum of a signal to be transmitted from the relay station 103e, and inputs the generated spectrum to the mapping unit 2907. The allocation information acquirer 2911 acquires the allocation information of the transmission signal of the terminal 101e, and inputs the acquired information to the signal processor 2906. A configuration of the signal processor 2906 is described later.

The transmission spectrum of the relay station 103e output from the signal processor 2906 is input to the mapping unit 2907. The mapping unit 2907 maps the transmission spectrum on the frequency (subcarrier) to be used, based on allocation information that is used between the relay station 103e and the base station 102e input from the allocation information acquirer 2911. The output of the mapping unit 2907 is input to the OFDM signal generator 2908.

The OFDM signal generator 2908 performs processing similar to that of the OFDM signal generator 2806 in the terminal 101e, and then the result is input to the transmitter 2909. The transmitter 2909 performs processing similar to that of the transmitter 2807 in the terminal 101e, and then the result signal is transmitted to the base station 102e through the transmit antenna 2910. Also, when the relay station 103e transmits a SRS to the base station 102e, the OFDM signal generator performs multiplexing of the SRS like the other embodiments. At this time, like DRMS, if frequencies that are respectively used by the SRS transmitted from the terminal 101e and the SRS transmitted from the relay station 103e partly overlap each other, frequency domain cyclic shift is provided so that the same spectrum is transmitted with each frequency, and time domain cyclic shift is further provided so that the signals can be separated in the base station 102e. In contrast, if the frequency to be used for the SRS transmitted from the relay station 103e and the frequency to be used for the SRS the terminal 101e are completely aligned with each other, the frequency domain shift is not performed.

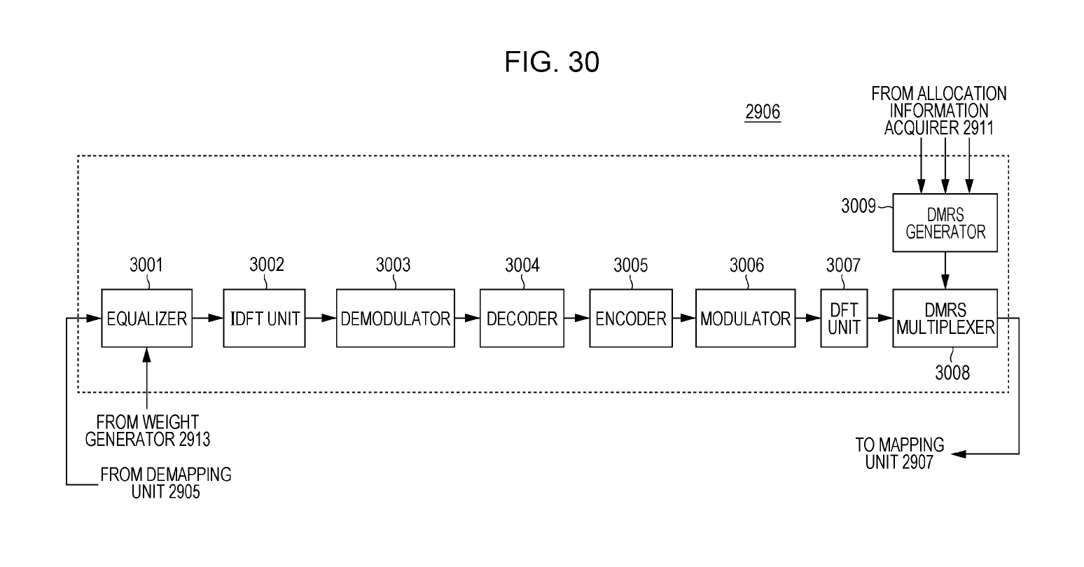

FIG. 30 is a brief block diagram showing a configuration of the signal processor 2906.

The signal processor 2906 includes an equalizer 3001, an IDFT unit 3002, a demodulator 3003, a decoder 3004, an encoder 3005, a modulator 3006, a DFT unit 3007, a DMRS multiplexer 3008, and a DMRS generator 3009.

The spectrum extracted by the demapping unit 2905 (FIG. 29) is input to the equalizer 3001. The equalizer 3001 performs equalization by multiplying the input spectrum with the input from the weight generator 2913 (FIG. 29), and inputs the equalized spectrum to the IDFT unit 3002.

The IDFT unit 3002 performs inverse discrete Fourier transform (IDFT), so that a frequency domain signal is converted into a time domain signal, and inputs the time domain signal to the demodulator 3003. The demodulator 3003 performs a demodulation method on the input time domain signal, based on the demodulation method performed at the transmission side, and hence converts the input time domain signal into a bit sequence.

The output of the bit sequence from the demodulator 3003 is input to the decoder 3004. The decoder 3004 performs error correction decoding on the bit sequence, and outputs the bit sequence of data after the error correction decoding to the encoder 3005.

The encoder 3005, the modulator 3006, and the DFT unit 3007 perform processing similar to the respective blocks (the modulator 2802 and the DFT unit 2803) in the terminal 101e (FIG. 28).

Also, a ZC sequence index q used by the terminal 101e for transmission and a cyclic shift amount in the time domain to be used by the relay station 103e are extracted, and are input to the signal processor 2906. The DMRS generator 3009 generates a ZC sequence of a DMRS based on the ZC sequence index q used for transmission by the terminal 101e and the cyclic shift amount in the time domain to be used by the relay station 103e, which are input from the allocation information acquirer 2911, and then successively performs frequency domain cyclic shift, cyclic extension, and time domain cyclic shift. Then, the sequence of the DMRS after the frequency domain cyclic shift, the cyclic extension, and the time domain cyclic shift is input as a demodulation reference signal DMRS to the DMRS multiplexer 3008. Here, the same ZC sequence index as that used by the terminal is used. Hence, the same spectra for the terminal 101e and the relay station 103e are transmitted as reference signals. In contrast, since the time domain cyclic shift that is different from the time domain cyclic shift used by the terminal 101e is used, the two reference signals can be easily separated in the base station.

The DMRS multiplexer 3008 multiplexes a data signal output from the DFT unit 3007 on the demodulation reference signal DMRS output from the DMRS generator 3009, and forms a transmission frame.

Then, the output of the DMRS multiplexer 3008 is input as an output of the signal processor 2906 (FIG. 29) to the mapping unit 2907.

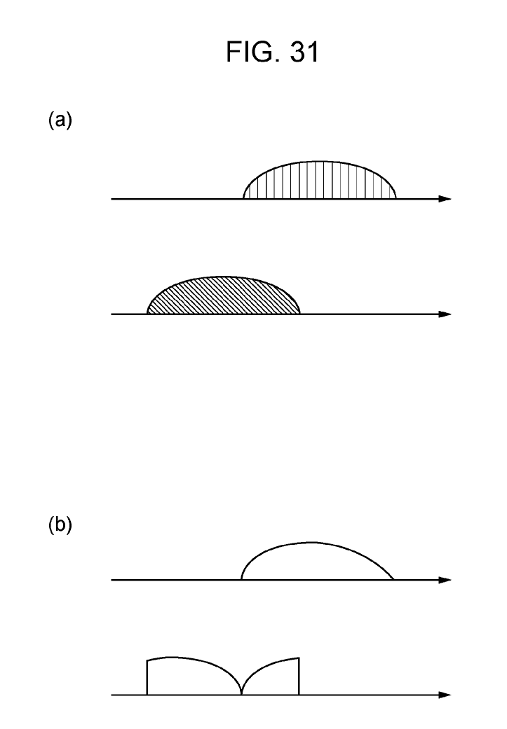

FIG. 31a shows a case in which a band of frequencies used by the terminal 101e for data transmission to the base station 102e and a band of frequencies used by the relay station 103e for data transmission to the base station 102e partly overlap each other. The horizontal axis plots the frequency.

The upper row in FIG. 31(a) shows the frequencies that are used by the terminal 101e for data transmission to the base station 102e, the frequencies being indicated by hatching with vertical lines. The lower row in FIG. 31(a) shows the frequencies that are used by the relay station 103e for data transmission to the base station 102e, the frequencies being indicated by hatching with oblique lines. Both regions partly overlap each other.

The upper row in FIG. 31(b) shows frequency arrangement of a demodulation reference signal DMRS that is used by the terminal 101e for transmission to the base station 102e. The lower row in FIG. 31(b) shows frequency arrangement of a demodulation reference signal DMRS that is used by the relay station 103e for transmission to the base station 102e. In both cases, the horizontal axis plots the frequency.

In FIG. 31(b), the demodulation reference signals DMRS in the upper row and the lower row partly overlap each other on the frequency axis, and have the same spectrum with frequencies of overlap allocation.

Data is transmitted with the allocation as shown in FIG. 31(a), and the data is received by the base station 102e. At this time, with a transmission method similar to the conventional method, different spectra are transmitted at respective frequency points (subcarriers). Hence, separation cannot be performed by the cyclic shift in the time domain. Accordingly, similarly to the other embodiments, a cyclic shift in the frequency domain is applied as shown in FIG. 31(b) to a DMRS so that the DMRS of the same spectrum is transmitted at each frequency point.

For example, the DMRS generator 3009 has a configuration similar to that in FIG. 4. As a result, the DMRS generator 3009 can generate a DMRS that is transmitted by the terminal 101e, and a DMRS formed of the same spectrum at each frequency point.

Also, if a signal that is received by the base station 102e through the relay station 103e and a signal of the other terminal are received by the base station 102e in a partly overlapped manner, or if a signal that is transmitted from the terminal 101e and a signal the bandwidth of which is changed by the relay station 103e are received by the base station 102e in a partly overlapped manner, reference signals of different sequences are generated between overlap signals. In this case, a DMRS generator is used to generate reference signals formed of the same sequence between the overlap signals is used. For example of the DMRS, the DMRS generator which is illustrated in FIG. 11 and the operation of which has been described with reference to the drawing may be used.

As described above, a signal transmitted from the terminal 101e and a signal transmitted from the relay station 103e are received by receive antennas 3201-0 to 3201-Nᵣ−1 of the base station 102e through radio channels, and hence reception of the transmission signal is performed.

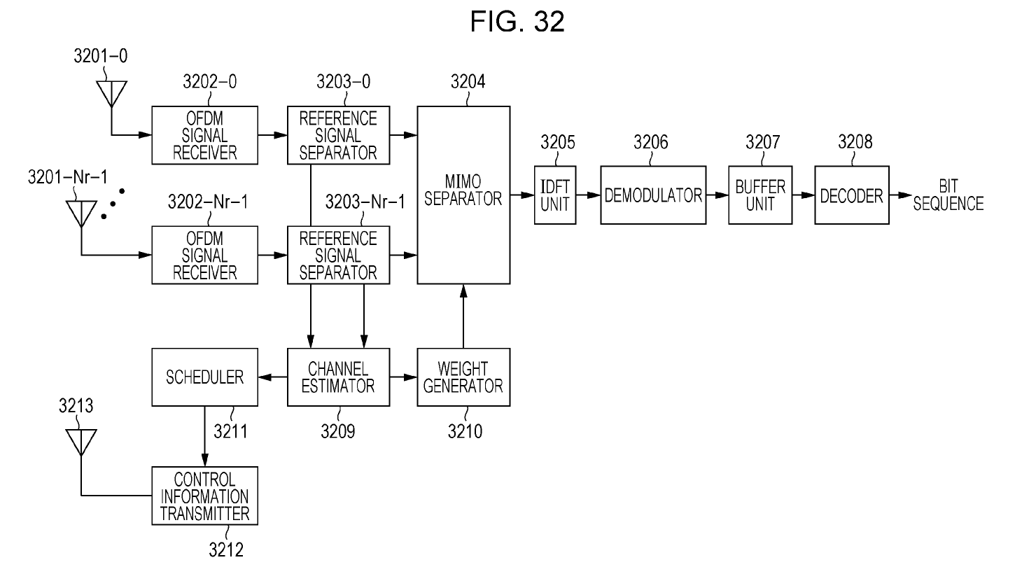

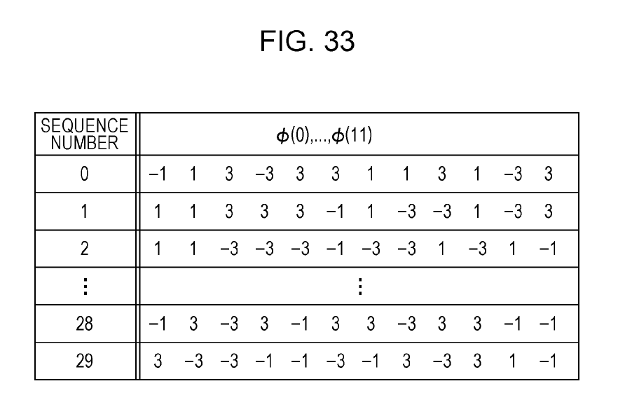

FIG. 32 is a brief block diagram showing a configuration of the base station 102e.

The base station 102e includes the receive antennas 3201-0 to 3201-Nᵣ−1, OFDM signal receivers 3202-0 to 3202-Nᵣ−1, reference signal separators 3203-0 to 3203-Nᵣ−1, a MIMO separator 3204, an IDFT unit 3205, a demodulator 3206, a buffer unit 3407, a decoder 3208, a channel estimator 3209, a weight generator 3210, a scheduler 3211, a control information transmitter 3212, and a transmit antenna 3213.

Described hereinafter are a case in which a signal transmitted by single carrier transmission from the terminal 101e is received, and a case in which signals transmitted from the terminal 101e and the relay station 103e are simultaneously received, by using the receive antennas 3201-0 to 3201-Nᵣ−1 of the base station 102e.

Other known configuration included in the base station 102e is omitted in FIG. 32 for easier understanding of the description, like the other embodiments.

Signals received by the receive antennas 3201-0 to 3201-Nᵣ−1 of the base station 102e are respectively input to the OFDM signal receivers 3202-0 to 3202-Nᵣ−1.

The subsequent signal processing is substantially the same as that of the configuration of the base station according to the other embodiments (for example, first embodiment). Hence, only the MIMO separator 3204 and the buffer unit 3207, which are features of this embodiment, are described.

When the terminal 101e including the single transmit antenna receives a signal, the MIMO separator 3204 multiplies the signal with a weight input from weight generator 3410 and performs receive antenna composition. Hence, the MIMO separator 3204 equalizes the signal so as to obtain a receive antenna diversity gain, and inputs the equalized signal to the IDFT unit 3205.

In contrast, if a signal transmitted from the terminal 101e and a signal transmitted from the relay station 103e are simultaneously received, since the weight that can separate the signals is input from the weight generator 3210, the MIMO separator 3204 multiplies the signals with the weight and separates the signals. The separated signal relayed through the relay station 103e is input to the IDFT unit 3205.

Here, demodulation of the signal relayed through the relay station 103e is described, and signal processing for a signal other than the relayed signal is omitted.

The signal transmitted to the base station 102e directly from the terminal 101e and the signal relayed through the relay station 103e are converted by the IDFT unit 3205 from frequency domain signals to time domain signals, and then are converted by the demodulator 3206 to LLR of a bit sequence. The output of the demodulator 3206 is input to the buffer unit 3207.

The buffer unit 3207 saves the LLR of the signal transmitted from the terminal 101e directly to the base station 102e. If LLR of the signal received by the base station 102e through the relay station 103e is input, the LLR is composed with the LLR of the signal transmitted to the base station 102e directly from the terminal 101e, and the composite LLR is input to the decoder 3208. The decoder 3208 performs error correction decoding by using the input LLR, and outputs a hard decision value of an obtained data bit.

In this embodiment, the example is described in which the buffer unit 3207 composes the LLRs before decoding. However, the composition method of two signals is not limited thereto. When the LLRs are composed, a weight may be composed in accordance with a channel gain, or since signals are received at different times, MIMO separation may be performed while it is assumed that the number of antennas is doubled.

As described above, when the signal from the terminal and the signal from the relay station are received while being partly overlapped each other, the DMRS generated at the relay station uses the same spectrum as the spectrum of the DMRS transmitted from the terminal with each frequency, the cyclic shift is applied, and the signals are transmitted. Accordingly, the channel estimator can estimate the channel between the terminal and the base station and the channel between the relay station and the base station with high accuracy. As a result, since an error rate performance of data is improved, throughput can be increased.

As described above, this embodiment relates to the case in which the signal transmitted from the terminal is transmitted to the base station through the relay, and the base station receives the signal directly transmitted from the terminal and the signal transmitted through the relay station in a multiplexed manner. The relay station applies the cyclic shifts in the frequency domain to the reference signals, and hence the spectrum of the reference signal transmitted from the terminal and the spectrum of the reference signal transmitted from the relay station can be aligned with each other. As a result, the relay station merely performs the cyclic shift in the time domain different from that of the reference signal transmitted from the terminal, and hence the reference signals transmitted from the terminal and the relay station can be easily separated from each other.

Some functions of the respective units of the terminal and base station relating to the embodiments of the present invention may be realized not with hardware but with software by using a computer program. To realize the functions, a CPU (central processing unit), various storage devices, etc., may be arranged in the terminal or base station, and the computer program that controls the CPU etc. may run so as to realize the functions. Also, information handled by the devices are temporarily accumulated in a RAM during processing, then stored in various ROMs and HDDs, and read, corrected, and written by the CPU as required. A storage medium that stores the program may be a semiconductor medium (for example, ROM, or non-volatile memory card), an optical storage medium (for example, DVD, MO, MD, CD, or BD), and a recording medium (for example, magnetic tape, or flexible disk). Also, not only the functions of the above-described embodiments are realized by executing the program stored in the storage device, but also functions of the present invention may be realized by performing processing in cooperation with an operation system or other application program based on an instruction of the program.

Also, when the computer program is distributed in the market, the program may be stored in a portable storage medium and distributed, or the program may be transferred to a server computer that is connected through a network such as the Internet, downloaded, and distributed in the market. In this case, the server including the storage device that stores the computer program is included in the technical range of the present invention. Also, one or both of the hardware and software that realize part or entirety of the configuration of the terminal or the base station according to the above-described embodiments may be formed of a semiconductor integrated circuit. Alternatively, the function blocks of the terminal or the base station may be individually formed into chips by using semiconductor integrated circuits, or all of the functions blocks may be integrated and realized with a single semiconductor chip. Also, a method of forming an integrated circuit is not limited to LST, and may be realized by a dedicated circuit or a general processor.

The embodiments of the present invention have been described in detail with reference to the drawings. However, the specific configuration is not limited to the embodiments, and a design etc. within a range not departing from the scope of the present invention is also included in the technical range of the claims.

### INDUSTRIAL APPLICABILITY

The present invention can be used for mobile communication and fixed communication in which a mobile phone device or a mobile information terminal serves as a terminal device.

### REFERENCE SIGNS LIST

101 terminal
102 base station
201 encoder
202 S/P converter
203 modulator
204 DFT unit
205 DMRS multiplexer
206 mapping unit
207 OFDM signal generator
208 transmitter
209 transmit antenna
210 receive antenna
211 control information receiver
212 DMRS generator
213 SRS generator
401 ZC sequence generator 402 frequency domain cyclic shifter
403 cyclic extender
404 time domain cyclic shifter
406 bandwidth acquirer
407 maximum prime number calculator
408 modulus operator
703 reference signal separator
704 MIMO separator
705 IDFT unit
709 channel estimator
710 weight generator
711 scheduler
801 vector generator
802 weight multiplier
803 demapping unit
1405 precoder
2301 SRS multiplexer
2409 comb spectrum generator
103e relay station

1. One or a plurality of transmission devices each of which includes one or a plurality of transmit antennas, the transmission device comprising:
a mapping unit that provides a frequency allocation that is different for each of the transmit antennas; and
a reference signal generator that determines a reference signal sequence for each of the transmit antennas so that the same sequence is transmitted from the transmit antenna with each frequency after the mapping by the mapping unit.

2. The transmission device according to claim 1,
wherein the reference signal generator includes
a reference signal sequence generator that generates a single reference signal sequence, and
a frequency domain cyclic shifter that applies a cyclic shift in the frequency domain to the reference signal sequence and hence generates the reference signal sequence for each of the transmit antennas.

3. The transmission device according to claim 2, wherein the reference signal generator includes a cyclic extender that cyclically extends an output of the frequency domain cyclic shifter so that the output matches a bandwidth of the frequency allocation.

4. The transmission device according to claim 3, wherein the reference signal sequence generator generates the reference signal sequence based on a frequency allocation to a path of an antenna with the widest frequency allocation among the transmit antennas by the mapping unit.

5. The transmission device according to claim 1, wherein the reference signal is a demodulation reference signal.

6. The transmission device according to claim 1, wherein the reference signal is a sounding reference signal.

7. A reception device including one or a plurality of receive antennas, the reception device comprising:
a reference signal separator that separates a received reference signal from a data signal;
a weight generator that generates a weight without inverse matrix calculation; and
a MIMO separator that separates the received data signal by using the weight.

8. A communication system including one or a plurality of transmission devices each of which includes one or a plurality of transmit antennas, and a reception device which includes one or a plurality of receive antennas that receive a signal transmitted from the transmission device,
wherein the transmission device includes a mapping unit that provides a frequency allocation that is different for each of the transmit antennas, and a reference signal generator that determines a reference signal sequence for each of the transmit antennas so that the same sequence is transmitted from the transmit antenna with each frequency after the mapping by the mapping unit, and
wherein the reception device includes a reference signal separator that separates a received reference signal from a data signal, a weight generator that generates a weight without inverse matrix calculation, and a MIMO separator that separates the received data signal by using the weight.

9. A transmission method, comprising:
mapping a frequency allocation that is different for each of one or a plurality of transmit antennas, for a reference signal and a data signal; and
after the mapping, transmitting the reference signal and the data signal from the transmit antenna with each frequency, and during the transmission of the reference signal and the data signal, transmitting a reference signal sequence that is the same sequence for each of the transmit antennas.

10. A reception method, comprising:
separating a received reference signal from a data signal;
generating a weight without inverse matrix calculation; and
separating the received data signal by using the weight.

11. A communication method, comprising:
mapping a frequency allocation that is different for each of one or a plurality of transmit antennas, for a reference signal and a data signal;
after the mapping, transmitting the reference signal and the data signal from the transmit antenna with each frequency;
separating the received reference signal from the data signal;
generating a weight without inverse matrix calculation; and
separating the received data signal by using the weight.

12. A semiconductor chip comprising a semiconductor integrated circuit that realizes a function of the transmission device according to claim 1.

13. A relay device that receives a signal transmitted from one or a plurality of transmission devices and relays the signal to a reception device, the relay device comprising:
a mapping unit that provides a frequency allocation that is different from a frequency allocation of the transmission device; and
a reference signal generator that determines a reference signal sequence so that the same sequence as a sequence from the transmission device is transmitted with each frequency after the mapping by the mapping unit.

14. A relay method, comprising:
receiving a signal transmitted from one or a plurality of transmission devices;
mapping a frequency allocation that is different form a frequency allocation for the transmission device, for the received signal; and
during the mapping, determining a reference signal sequence so that the same sequence as a sequence from the transmission device is transmitted with each frequency.
